(19) United States
(12) Patent Application Publication
(10) Pub. No.: US 2026/0054168 A1
(43) Pub. Date: Feb. 26, 2026

(54) VIRTUAL OBJECT DISPLAY METHOD AND APPARATUS, COMPUTER-READABLE STORAGE MEDIUM, COMPUTER PROGRAM PRODUCT, AND ELECTRONIC DEVICE

(71) Applicant: Tencent Technology (Shenzhen) Company Limited, Shenzhen (CN)

(72) Inventors: Jieqi XIE, Shenzhen (CN); Chuhui WANG, Shenzhen (CN)

(73) Assignee: Tencent Technology (Shenzhen) Company Limited, Shenzhen (CN)

(21) Appl. No.: 19/379,238

(22) Filed: Nov. 4, 2025

Related U.S. Application Data
(63) Continuation of application No. PCT/CN2024/123885, filed on Oct. 10, 2024.

(30) Foreign Application Priority Data
Dec. 14, 2023 (CN) 202311730134.4

(51) Int. Cl. A63F 13/52; A63F 13/79; A63F 13/822

(52) U.S. Cl. CPC A63F 13/52; A63F 13/79; A63F 13/822

(57) ABSTRACT

The present disclosure discloses a virtual object display method includes: displaying a first virtual scene corresponding to a first account in a current match, displaying a second virtual scene corresponding to a second account and a first virtual object in response to a first interaction operation performed by the first account in the first virtual scene, where the first interaction operation is an operation of determining the first virtual object from a group of virtual objects and determining the second account from accounts in the group of accounts other than the first account; and displaying the first virtual object in a target region in response to a second interaction operation performed by the first account in the second virtual scene, where the second interaction operation is an operation of determining the target region from the second virtual scene by the first account.

### RELATED APPLICATION

This application is a continuation of and claims the benefit of priority to PCT Application No. PCT/CN2024/123885, filed October 10, 2024, and entitled VIRTUAL OBJECT DISPLAY METHOD AND APPARATUS, COMPUTER READABLE STORAGE MEDIUM, COMPUTER PROGRAM PRODUCT AND ELECTRONIC DEVICE, which is based on and claims the benefit of priority to Chinese Patent Application No. 202311730134.4 filed on December 14, 2023. The above applications are incorporated herein by reference in their entireties.

### FIELD OF THE TECHNOLOGY

The present disclosure relates to the computer field, and specifically, to a virtual object display method and apparatus, a computer-readable storage medium, a computer program product, and an electronic device.

### BACKGROUND OF THE DISCLOSURE

Currently, there are situations in which a plurality of accounts participate in the same virtual scene. The plurality of accounts participating in the virtual scene may exchange their respective virtual objects with one another through gifting or trading. In the related art, when a sender transfers a virtual object to a recipient, a virtual scene of the sender can only be obtained from a perspective of the sender, and a perspective of the recipient is different from the perspective of the sender. When the sender transfers the virtual object to the recipient, the recipient needs to configure the virtual object before it can be used, and this configuration takes time to complete. As a result, the cooperation between the sender and the recipient is inefficient, causing a technical problem of low processing efficiency of the virtual object after the transfer of the virtual object.

### SUMMARY

Embodiments of the present disclosure provide a virtual object display method and apparatus, a computer-readable storage medium, a computer program product, and an electronic device, to at least improve processing efficiency of a virtual object.

An embodiment of the present disclosure provides a virtual object display method. The method is performed by an electronic device and includes:

displaying a first virtual scene corresponding to a first account in a current match, accounts participating in the current match including a group of accounts, the group of accounts including the first account, and the first virtual scene displaying a group of virtual objects owned by the first account; displaying a second virtual scene corresponding to a second account and a first virtual object in response to a first interaction operation performed by the first account in the first virtual scene, the first interaction operation being an operation of determining the first virtual object from the group of virtual objects and determining the second account from account in the group of accounts other than the first account; and displaying the first virtual object in a target region in the second virtual scene in response to a second interaction operation performed by the first account in the second virtual scene, the second interaction operation being an operation of determining the target region from the second virtual scene, and the display of the first virtual object in the target region indicating that the first virtual object is owned by the second account.

An embodiment of the present disclosure provides a virtual object display apparatus. The apparatus includes:

a first display module, configured to display a first virtual scene corresponding to a first account in a current match, accounts participating in the current match including a group of accounts, the group of accounts including the first account, and the first virtual scene displaying a group of virtual objects owned by the first account; a second display module, configured to display a second virtual scene corresponding to a second account and a first virtual object in response to a first interaction operation performed by the first account in the first virtual scene, the first interaction operation being an operation of determining the first virtual object from the group of virtual objects and determining the second account from accounts in the group of accounts other than the first account; and a third display module, configured to display the first virtual object in a target region in the second virtual scene in response to a second interaction operation performed by the first account in the second virtual scene, the second interaction operation being an operation of determining the target region from the second virtual scene, and the display of the first virtual object in the target region indicating that the first virtual object is owned by the second account.

An embodiment of the present disclosure provides a computer-readable storage medium. The computer-readable storage medium has a computer program or computer-executable instructions stored therein. The computer program or the computer-executable instructions are configured to perform, when executed, the foregoing virtual object display method.

An embodiment of the present disclosure provides a computer program product. The computer program product includes a computer program or computer-executable instructions. The computer program or the computer-executable instructions are stored in a computer-readable storage medium. A processor of the electronic device reads the computer program or the computer-executable instructions from the computer-readable storage medium, and the processor executes the computer program or the computer-executable instructions, to cause the electronic device to perform the foregoing virtual object display method.

An embodiment of the present disclosure provides an electronic device, including a memory and a processor. The memory has a computer program or computer-executable instructions stored therein. The processor is configured to perform the foregoing virtual object display method through the computer program or the computer-executable instructions.

According to the embodiments of the present disclosure, a first virtual scene corresponding to a first account in a current match is displayed, where accounts participating in the current match include a group of accounts, the group of accounts includes the first account, and the first virtual scene displays a group of virtual objects owned by the first account; a second virtual scene corresponding to a second account and a first virtual object are displayed in response to a first interaction operation performed by the first account in the first virtual scene, where the first interaction operation is an operation of determining the first virtual object from the group of virtual objects and determining the second account from accounts in the group of accounts other than the first account; and a first virtual object is displayed in a target region in the second virtual scene in response to a second interaction operation performed by the first account in the second virtual scene, where the second interaction operation is an operation of determining the target region from the second virtual scene, and the display of the first virtual object in the target region indicates that the first virtual object is owned by the second account. The first account performs the first interaction operation, so that at least one of the virtual objects owned can be determined as the first virtual object in the first virtual scene, and the second virtual scene corresponding to the second account is displayed through the first interaction operation. The first account performs the second interaction operation, so that the first virtual object can be displayed in the second virtual scene. In this way, the first account can assist the second account, to process the first virtual object shared by the first account, thereby improving the processing efficiency of the virtual object. This resolves a technical problem of low processing efficiency of the virtual object after the transfer of the virtual object, which is caused by the complexity of communication between accounts.

In addition, the first account can quickly determine the target region through the second interaction operation in the second virtual scene. After the target region is determined, the first virtual object can be automatically placed into the target region, so that the first account assists the second account in processing the first virtual object. In other words, by using the virtual object display method provided in the present disclosure, decision-making pressure of the second account when receiving the first virtual object can be reduced, thereby simplifying an operation process of the second account for the first virtual object, and improving gaming experience.

### BRIEF DESCRIPTION OF THE DRAWINGS

The accompanying drawings herein are configured for providing a further understanding of the present disclosure and constitute a part of the present disclosure. Exemplary embodiments of the present disclosure and the descriptions thereof are intended to explain the present disclosure, and do not constitute any limitation on the present disclosure. In the accompanying drawings:

FIG. 1 is an example schematic diagram of an application environment of an exemplary virtual object display method according to an embodiment of the present disclosure.

FIG. 2 is an example schematic flowchart of an exemplary virtual object display method according to an embodiment of the present disclosure.

FIG. 3 is an example schematic diagram of an exemplary virtual object display method according to an embodiment of the present disclosure.

FIG. 4 is an example schematic diagram of another exemplary virtual object display method according to an embodiment of the present disclosure.

FIG. 5 is an example schematic diagram of another exemplary virtual object display method according to an embodiment of the present disclosure.

FIG. 6 is an example schematic diagram of another exemplary virtual object display method according to an embodiment of the present disclosure.

FIG. 7 is an example schematic diagram of another exemplary virtual object display method according to an embodiment of the present disclosure.

FIG. 8 is an example schematic diagram of another exemplary virtual object display method according to an embodiment of the present disclosure.

FIG. 9 is an example schematic diagram of another exemplary virtual object display method according to an embodiment of the present disclosure.

FIG. 10 is an example schematic diagram of another exemplary virtual object display method according to an embodiment of the present disclosure.

FIG. 11 is an example schematic diagram of another exemplary virtual object display method according to an embodiment of the present disclosure.

FIG. 12 is an example schematic diagram of another exemplary virtual object display method according to an embodiment of the present disclosure.

FIG. 13 is an example schematic diagram of another exemplary virtual object display method according to an embodiment of the present disclosure.

FIG. 14 is an example schematic diagram of another exemplary virtual object display method according to an embodiment of the present disclosure.

FIG. 15 is an example schematic diagram of another exemplary virtual object display method according to an embodiment of the present disclosure.

FIG. 16 is an example schematic diagram of another exemplary virtual object display method according to an embodiment of the present disclosure.

FIG. 17 is an example schematic structural diagram of an exemplary virtual object display apparatus according to an embodiment of the present disclosure.

FIG. 18 is an example schematic structural diagram of an exemplary virtual object display product according to an embodiment of the present disclosure.

FIG. 19 is an example schematic structural diagram of an exemplary electronic device according to an embodiment of the present disclosure.

### DESCRIPTION OF EMBODIMENTS

To make a person skilled in the art understand solutions of the present disclosure better, the following clearly and completely describes the technical solutions in embodiments of the present disclosure with reference to the accompanying drawings in the embodiments of the present disclosure. Apparently, the described embodiments are merely a part rather than all of embodiments of the present disclosure. Based on the embodiments of the present disclosure, all other embodiments obtained by a person of ordinary skill in the art without creative efforts fall within the protection scope of the present disclosure.

In the specification, claims, and accompanying drawings of the present disclosure, the terms "first", "second", and the like are intended to distinguish between similar objects but do not necessarily indicate a specific order or sequence. The data used in such a way is interchangeable in proper circumstances, so that the embodiments of the present disclosure described herein can be implemented in other sequences than the sequence illustrated or described herein. In addition, the terms "comprise", "include", "have", and any variants thereof are intended to cover the non-exclusive inclusion. For example, a process, method, system, product, or device that includes a series of steps or units is not necessarily limited to those steps or units expressly listed, but can include other steps or units not expressly listed or inherent to such a process, method, product, or device.

First, some terms appearing in the descriptions of the embodiments of the present disclosure are defined as follows.

(1) Auto chess: It is a type of tactical strategy video game, usually featuring elements similar to chess, and in some ways also considered a strategy board game. Players place virtual objects on a grid-shaped battlefield during the preparation phase. The virtual objects then automatically battle against each other, usually without requiring further input from the players. The players build their in-game economies and use the virtual objects to battle against each other, with the battle automatically occurring between the virtual objects during the battle phase of the game.

(2) Virtual scene: It is a virtual scene displayed (or provided) when an application (for example, a game) runs on a terminal. The virtual scene may be a simulated environment for real world, or may be a semi-simulated and semi-fictional virtual environment, or may be an entirely fictional virtual environment. The virtual scene may be any one of a two-dimensional virtual scene, a 2.5-dimensional virtual scene, or a three-dimensional virtual scene. This is not limited in the embodiments of the present disclosure.

(3) Virtual object: It is a representation of various persons and objects in a virtual scene that may interact with each other, or an active object in the virtual scene, for example, a virtual item in the virtual scene or a virtual character controlled by an account of a user (for example, a player described above) in the virtual scene. Different virtual objects in the embodiments of the present disclosure may interact with each other in a virtual scene, for example, through virtual attack, virtual defense, and virtual evasion.

(4) Account: It is a personal account created by a user in an application (for example, a game), and is a unique identifier of the user in the application. Using a game as an example, the account is an identity and a tool for the user to participate in the game, store game data, and manage game characters. In the embodiments of the present disclosure, accounts of different users may be distinguished as a first account and a second account. In addition, virtual scenes associated with different accounts may be distinguished as a first virtual scene and a second virtual scene.

(5) Interaction operation: It is an operation performed by a user when making relevant decisions such as controlling a virtual object in a virtual scene or issuing an instruction. For example, it is an operation of selecting a specific virtual object from virtual objects owned, or an operation of sharing the selected virtual object with a teammate. Different interaction operations in the embodiments of the present disclosure may be distinguished as a first interaction operation, a second interaction operation, and the like.

(6) Target region: It is a region into which a sharing party intends to place a virtual object to be shared. The region is located in a virtual scene of a recipient. Using an auto chess as an example, the target region may be a preparation region of the recipient, or may be a chessboard region of the recipient.

(7) Alternate region: It is a candidate region that may be configured for placing virtual objects when the target region can no longer accommodate virtual objects. It may be considered that the target region can no longer accommodate virtual objects if there are no available positions in the target region or the target region is locked.

(8) Cancel control: It is a control used by a sharing party to cancel sharing of a virtual object.

The present disclosure is described below with reference to the embodiments.

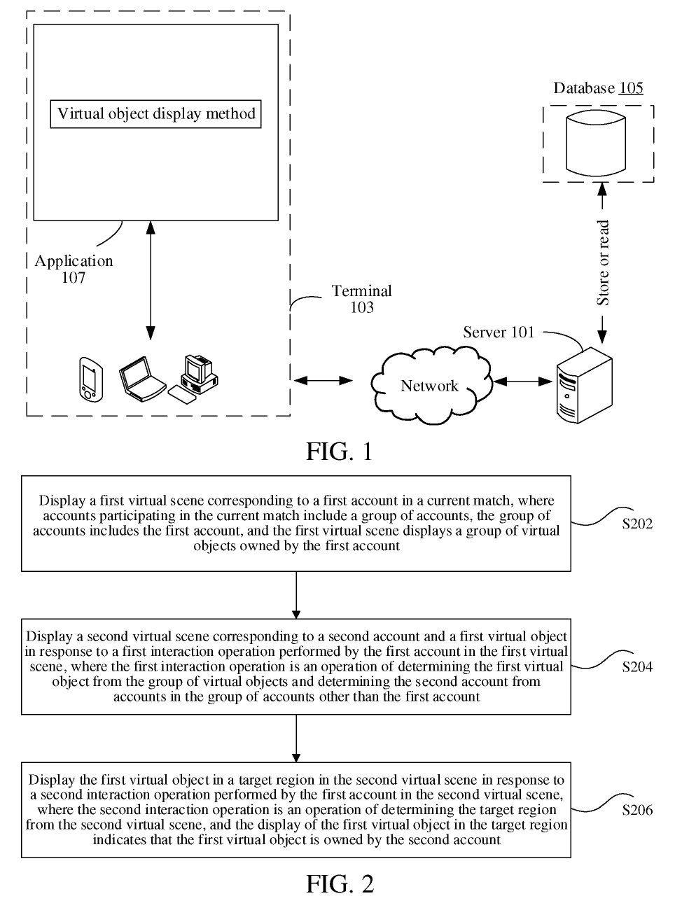

According to an aspect of the embodiments of the present disclosure, a virtual object display method is provided. In the embodiment of the present disclosure, the virtual object display method may be applied to a hardware environment composed of a server 101 and a terminal 103, as shown in FIG. 1. As shown in FIG. 1, the server 101 is connected to the terminal 103 through a network, and may be configured to provide a service for the terminal or an application 107 installed on the terminal. The application may be a video application, an instant messaging application, a browser application, an education application, a game application, or the like. A database 105 may be provided on the server or independently of the server, and is configured for providing a data storage service for the server 101, for example, a game data storage server. The network may include, but is not limited to, a wired network and a wireless network, where the wired network includes a local area network, a metropolitan area network, and a wide area network, and the wireless network includes Bluetooth, Wi-Fi, and other networks that implement wireless communication. The terminal 103 may be a terminal configured with an application, and may include, but is not limited to, at least one of the following: a mobile phone, a notebook computer, a tablet computer, a palmtop computer, a mobile Internet device (MID), a PAD, a desktop computer, a smart television, an intelligent voice interaction device, a smart home appliance, an in-vehicle terminal, an aircraft, a virtual reality (VR) terminal, an augmented reality (AR) terminal, a mixed reality (MR) terminal, or any other electronic device. The server may be a single server, or may be a server cluster including a plurality of servers, or may be a cloud server.

With reference to FIG. 1, the virtual object display method may be performed by an electronic device. The electronic device may be a terminal or a server. The virtual object display method may be separately implemented by the terminal or the server, or may be jointly implemented by the terminal and the server.

The foregoing descriptions are merely an example, and are not specifically limited in this embodiment.

The following describes the virtual object display method by using an example in which the electronic device is a terminal. In an implementation, as shown in FIG. 2, the virtual object display method includes the following operations.

S202: Display a first virtual scene corresponding to a first account in a current match, where accounts participating in the current match include a group of accounts, the group of accounts includes the first account, and the first virtual scene displays a group of virtual objects owned by the first account.

In this embodiment, the match may include, but is not limited to, a match of a multiplayer online battle arena (MOBA) game also referred to as an action real-time strategy (Action RTS, ARTS) game. The MOBA game may be run on a terminal (for example, a mobile phone or a PC), and a player may log in to the game by using the first account in the group of accounts, for example, an auto chess game application. The first account may be a registered game account, an account of a third-party application, or the like. The match may include, but is not limited to, being run in a game application, or may include, but is not limited to, being run in an associated mini program or web page in another application scenario.

The first account enters the match, and a plurality of accounts may coexist in the match. That is, a plurality of accounts can play the game simultaneously in a single match. For example, a plurality of accounts operate their respective virtual objects to battle, communicate, and the like. That is, the group of accounts includes a plurality of accounts, and the first account is one of the accounts in the group of accounts.

The player may use the first account on the terminal to enter the match through the terminal. A terminal display interface may display the first virtual scene corresponding to the first account. The first virtual scene may include, but is not limited to, virtual objects. The virtual objects may include, but are not limited to, game characters, virtual equipment, virtual pets, digital artworks, virtual real estate, objects in a virtual reality world, and the like. For example, the first account may use a game character to battle in a game application, or add virtual equipment to the game character in the game application. That is, virtual objects owned by the first account may be learned from the first virtual scene.

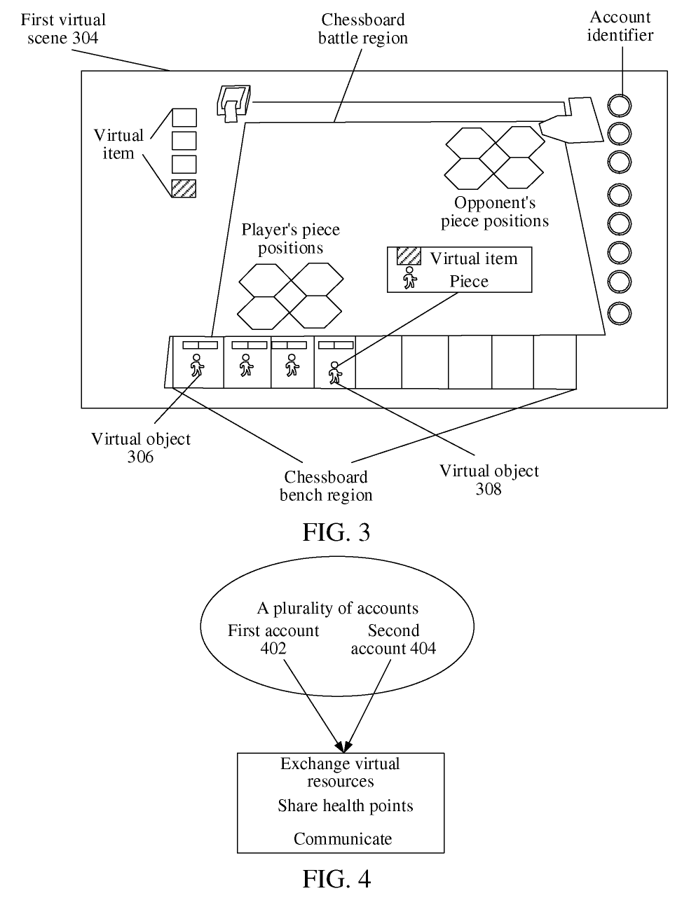

For example, FIG. 3 is a schematic diagram of an exemplary virtual object display method according to an embodiment of the present disclosure. Using an auto chess game application as an example, as shown in FIG. 3, a terminal display interface displays a first virtual scene 304. The first account owns a virtual object 306 and a virtual object 308. The first account may perform corresponding actions on the virtual object 306 and the virtual object 308, for example, gifting the virtual object 306 to another account in the game, or directly discarding the virtual object 308. The first virtual scene 304 includes a chessboard battle region and a chessboard bench region, where the chessboard battle region is provided with player's piece positions and opponent's piece positions. The first virtual scene 304 further displays a virtual item owned by the first account and an account identifier of another account participating in the current match.

S204: Display a second virtual scene corresponding to a second account and a first virtual object in response to a first interaction operation performed by the first account in the first virtual scene, where the first interaction operation is an operation of determining the first virtual object from the group of virtual objects and determining the second account from accounts in the group of accounts other than the first account.

In this embodiment of the present disclosure, the second account may be a registered game account, an account of a third-party application, or the like. The first interaction operation may include, but is not limited to, a touch operation performed on a touchscreen, or a touch operation performed through an input device such as a mouse, a keyboard, or a stylus.

For example, the first account and the second account enter the match simultaneously, and the terminal display interface of the second account displays the second virtual scene corresponding to the second account. The second virtual scene may include, but is not limited to, virtual objects and the like. The virtual objects may include, but are not limited to, game characters, virtual equipment, and the like. For example, the second account may use a game character to battle in the game, or add virtual equipment to the game character in the game. That is, virtual objects owned by the second account may be learned from the second virtual scene.

FIG. 4 is a schematic diagram of an exemplary virtual object display method according to an embodiment of the present disclosure. As shown in FIG. 4, if a plurality of accounts enter the current match simultaneously, the plurality of accounts include a first account 402 and a second account 404, and interactions between the first account 402 and the second account 404 may include, but are not limited to, communication, sharing health points, exchanging virtual resources, and the like. For example, when the first account 402 defeats any account in the plurality of accounts other than the first account 402 and the second account 404, and the second account 404 is still in battle, a remaining virtual resource of the first account 402, for example, a virtual object not yet used by the first account 402 in the battle, may be automatically transferred to the second account 404, to assist the second account 404 in the battle. The battle in the game may include, but is not limited to, a two-sided battle (for example, red side versus blue side), or a multi-sided battle (for example, one player per team or multiple players per team, engaging in battles involving more than two sides). Each side in the battle may have an operable virtual object or may have a plurality of operable virtual objects. The match may be divided into, but is not limited to, a preparation phase and a battle phase. During different game phases, perspectives of a game camera may be separately configured or uniformly configured.

In this embodiment of the present disclosure, the first account performs the first interaction operation in the first virtual scene. In other words, the first account selects one virtual object from virtual objects associated with the first account as the first virtual object through touchscreen input or the like, and determines the second account from a plurality of accounts participating in a round of game.

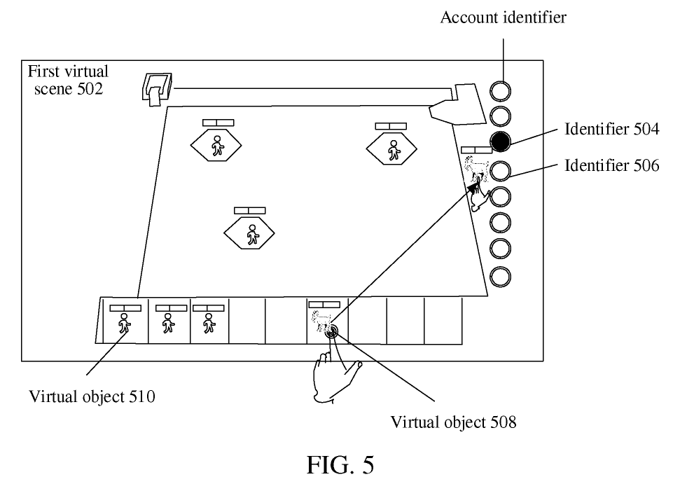

For example, FIG. 5 is a schematic diagram of an exemplary virtual object display method according to an embodiment of the present disclosure. As shown in FIG. 5, using an example in which the match is run in a game application, the first interaction operation may be implemented through the following operations. The first account is used on the terminal to enter a round of game. A first virtual scene 502 corresponding to the first account includes a first account identifier 504, a second account identifier 506, a virtual object 508, and a virtual object 510. The first virtual scene 502 is a game region corresponding to the first account in the game application, and the virtual object 508 and the virtual object 510 are virtual objects owned by the first account. In this case, when it is detected that a player selects the virtual object 508 through touchscreen input with a finger, the selected virtual object 508 is used as the first virtual object, and when it is detected that the player moves the virtual object 508 to the second account identifier 506 with the finger, the second account identifier 506 is highlighted, indicating that the first virtual object needs to be transferred to the second account.

In the present disclosure, the first account and the second account are both accounts in the group of accounts, and participate in the same match. In addition, the first account and the second account may be in a teammate relationship, or the first account and the second account are not teammates. In this case, the first account may still perform the first interaction operation in the first virtual scene, to determine the second account. The second account may transfer virtual resources to the first account to obtain the first virtual object. The virtual resources herein may include, but are not limited to, virtual coins and the like. For example, in a match, the first account is in a team A, the second account is in a team B. The first account posts a message in a public chat channel of the game, indicating that there are surplus first virtual objects available for sale. In this case, because the second account needs the first virtual object, the second account may communicate with the first account, which includes, but is not limited to, communicating in the public chat channel of the game, or initiating a chat request to the first account to communicate with the first account, to indicate the need for the first virtual object. Then, the first account may set the sale price of the first virtual object at five coins. If the second account indicates that the price is excessive, the price may be adjusted after the first account communicates with the second account. When the two parties reach an agreement on the price through communication, the second account transfers a corresponding quantity of coins to the first account, and the first account may determine the second account through the first interaction operation, to facilitate subsequent transfer of the first virtual object to the second account.

S206: Display the first virtual object in a target region in the second virtual scene in response to a second interaction operation performed by the first account in the second virtual scene, where the second interaction operation is an operation of determining the target region from the second virtual scene, and the display of the first virtual object in the target region indicates that the first virtual object is owned by the second account.

In this embodiment of the present disclosure, the second interaction operation may include, but is not limited to, a touch operation performed on a touchscreen, or a touch operation performed through an input device such as a mouse, a keyboard, or a stylus. The target region refers to a region into which the first account (namely, the sharing party described above) intends to place the first virtual object to be shared. The target region is arranged in the second virtual scene corresponding to the second account. Using an auto chess as an example, the target region may be a preparation region of the second account (namely, the recipient described above), or may be a chessboard region of the recipient. The target region may be any region in the second virtual scene.

For example, after detecting that the first account performs the first interaction operation in the first virtual scene, the terminal may display the second virtual scene. In other words, after the first account is used to enter the first virtual scene and performs the first interaction operation, content displayed on the terminal display interface changes. That is, the terminal display interface originally displays the first virtual scene, and the player may learn virtual objects owned by the first account in the first virtual scene. In this case, the first virtual object does not exist in the second virtual scene. After detecting that the first account performs the first interaction operation, the terminal display interface displays the second virtual scene, and the player may learn virtual objects owned by the second account in the second virtual scene. In this case, the second virtual scene includes the first virtual object. In other words, the foregoing process may be understood as allowing the first virtual object to appear in the second virtual scene through the first interaction operation performed by the first account in the first virtual scene.

After the first account enters the second virtual scene, the second interaction operation may be performed in the second virtual scene. Actions performed by the first account on the first virtual object in the second virtual scene may include, but are not limited to, tapping/clicking the first virtual object, double-tapping/clicking the first virtual object, long-pressing the first virtual object, dragging the first virtual object with a finger, and the like. The terminal determines the target region in the second virtual scene based on the second interaction operation performed by the first account in the second virtual scene. The target region is a region in the second virtual scene in which the first account places the first virtual object. In this case, the second virtual scene includes the first virtual object. In this way, the second account may perform an operation on the first virtual object, that is, the second account owns the first virtual object, thereby associating the second account with the first virtual object.

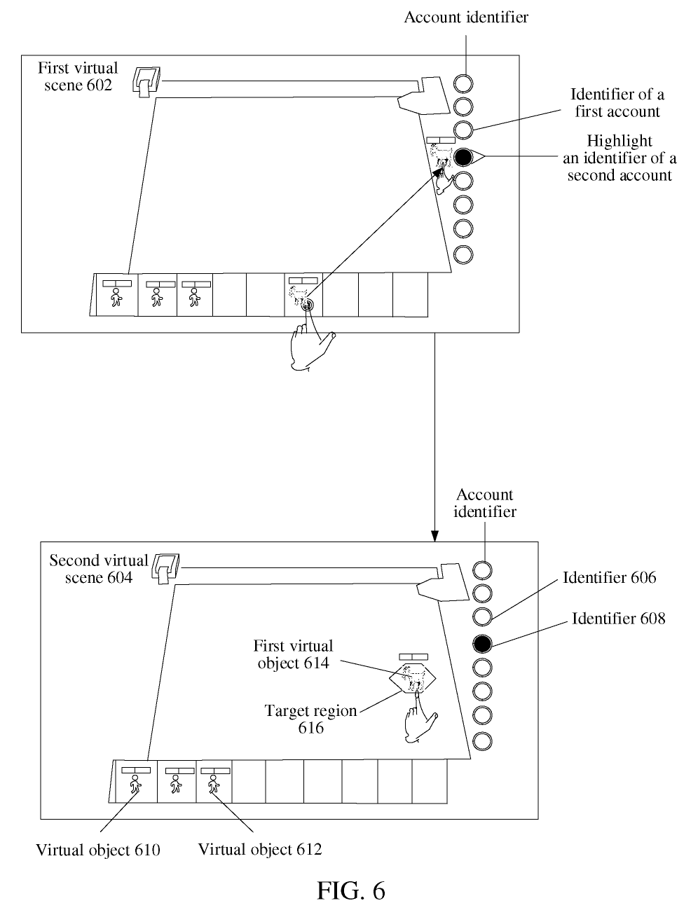

For example, FIG. 6 is a schematic diagram of an exemplary virtual object display method according to an embodiment of the present disclosure. As shown in FIG. 6, using an example in which the match is run in a game application, the second interaction operation may be implemented through the following operations.

A first account is logged in on the terminal. When detecting that the player performs a first interaction operation in a first virtual scene 602, the terminal displays a second virtual scene 604. The second virtual scene 604 includes a first account identifier 606, a second account identifier 608, a virtual object 610, and a virtual object 612. After displaying the second virtual scene 604, the terminal displays a first virtual object 614 in the second virtual scene 604, where the second virtual scene 604 is a game region corresponding to a second account in the game application, and the virtual object 610 and the virtual object 612 are virtual objects owned by the second account. The terminal displays the virtual object 610 and the virtual object 612 controlled by the second account in the second virtual scene 604. In this case, if the terminal detects that a player A drags the virtual object 614 with a finger to a target region 616, the virtual object 614 is transferred to be owned by the second account, that is, the virtual object 614 is changed into one of the virtual objects owned by the second account.

Using an auto chess game application as an example, the target region may be determined in the second virtual scene in the following manner, including but not limited to the following several cases:

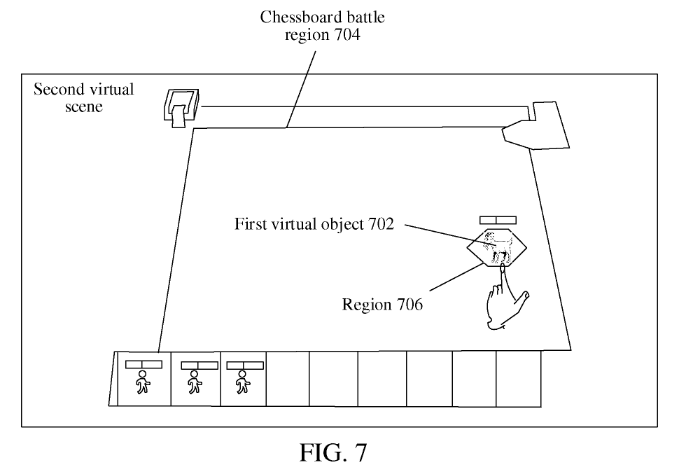

Case 1: a description is made with reference to FIG. 7. FIG. 7 is a schematic diagram of an exemplary virtual object display method according to an embodiment of the present disclosure. As shown in FIG. 7, the terminal detects that the player uses the first account to drag a first virtual object 702 to a region in a chessboard battle region 704 in the second virtual scene corresponding to the second account. If a quantity of virtual objects in the chessboard battle region 704 of the second account has not reached an upper quantity limit of virtual objects, the first virtual object 702 is placed as a piece into a region 706 in the chessboard battle region 704, where the virtual objects in the chessboard battle region 704 may participate in a current battle. In other words, when there is still an available region in the chessboard battle region 704 of the second account for placing a piece, if the terminal detects that the player uses the first account to drag the first virtual object 702 to a region in the chessboard battle region 704 of the second account, after it is detected that the player releases it, the first virtual object 702 is automatically placed into the available region in the chessboard battle region 704 of the second account as a virtual object of the second account to enter the current battle. In this case, the target region is determined as the region 706 in the chessboard battle region 704.

The upper quantity limit of virtual objects in the chessboard battle region of the second account may include, but is not limited to, being associated with an account level of the second account. For example, a higher account level of the second account indicates that more virtual objects can be placed into the chessboard battle region in a round of game.

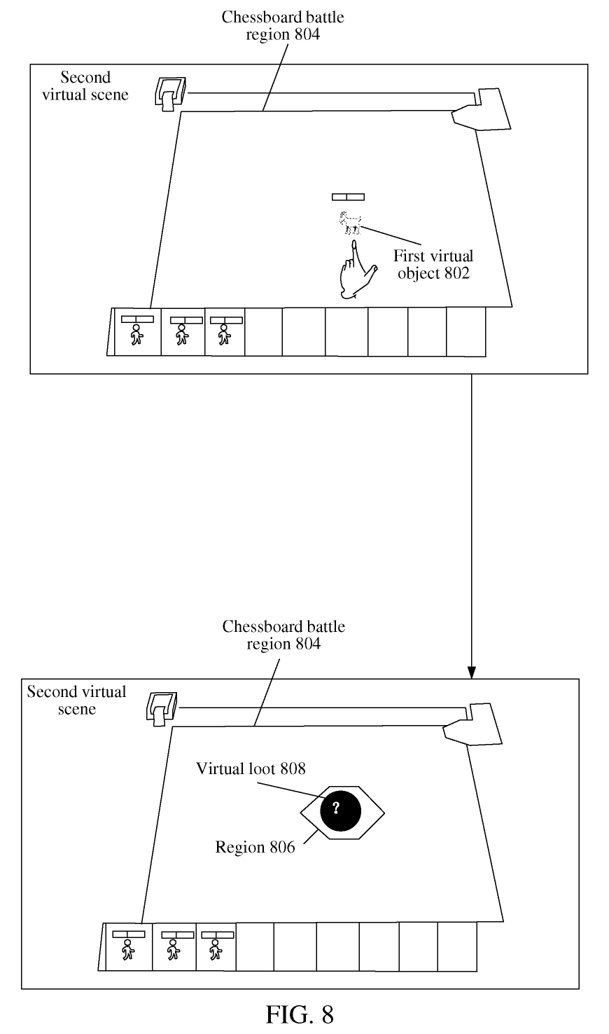

Case 2: a description is made with reference to FIG. 8. FIG. 8 is a schematic diagram of an exemplary virtual object display method according to an embodiment of the present disclosure. As shown in FIG. 8, the terminal detects that the player uses the first account to drag a first virtual object 802 to a region 806 in a chessboard battle region 804 in the second virtual scene corresponding to the second account. If a quantity of virtual objects in the chessboard battle region 804 has reached an upper quantity limit of virtual objects, a form of the first virtual object 802 may be changed. This may include, but is not limited to, transforming the first virtual object 802, which is originally in a form of a piece that may enter the current battle, into a virtual loot 808 that does not enter the current battle, and presenting the virtual loot 808 in the chessboard battle region 804 of the second account. The second account may pick up the virtual loot 808 in the chessboard battle region 804 in the following manners, including, but are not limited to, long-pressing the virtual loot 808, tapping/clicking the virtual loot 808, double-tapping/clicking the virtual loot 808, and the like. In other words, when the quantity of virtual objects in the chessboard battle region 804 of the second account has reached the upper quantity limit of virtual objects and there is no available region for placing the first virtual object 802, if the terminal detects that the first account drags the virtual object 802 to the region 806 in the chessboard battle region 804 of the second account, after the first account releases it, the first virtual object 802 is transformed into the virtual loot 808 that may be picked up by the second account. In this case, the target region is determined as the region 806 in the chessboard battle region 804.

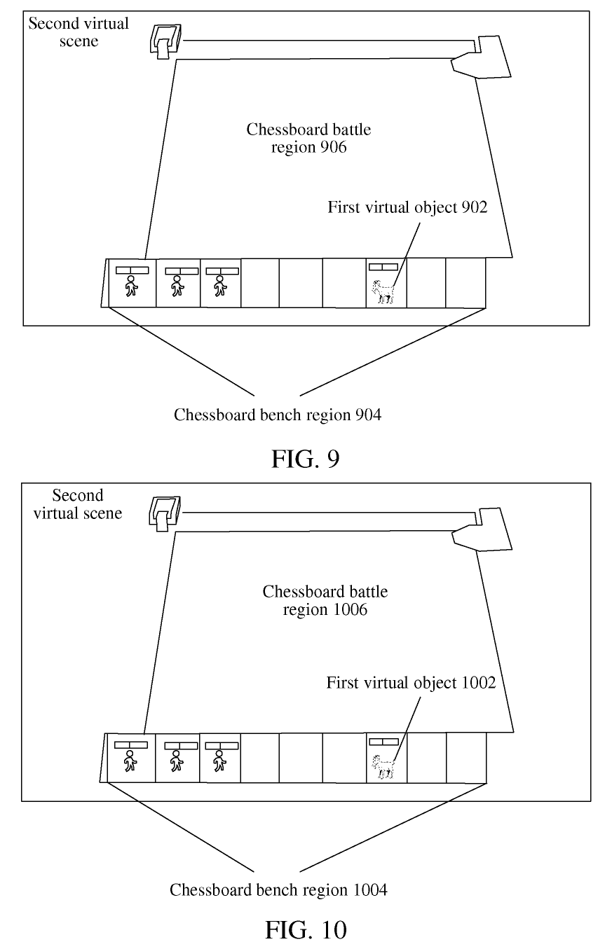

Case 3: a description is made with reference to FIG. 9. FIG. 9 is a schematic diagram of an exemplary virtual object display method according to an embodiment of the present disclosure. As shown in FIG. 9, the terminal detects that the player uses the first account to drag a first virtual object 902 to a chessboard bench region 904 in the second virtual scene corresponding to the second account. The chessboard bench region 904 of the second account may include, but is not limited to, a plurality of virtual objects. The virtual objects located in the chessboard bench region 904 of the second account are virtual objects that are owned by the second account, but do not participate in a current battle. These virtual objects can enter a chessboard battle region 906 for battle only when the second account sends an instruction instructing the virtual objects to participate in the battle. The virtual objects located in the chessboard bench region 904 of the second account may be upgraded. An upgrade manner may include, but is not limited to, the following: when a virtual object wins a battle, it usually obtains experience points, and after a quantity of experience points are accumulated, the virtual object is upgraded, or a level of the virtual object is directly increased by using a specific virtual item, or the virtual object is upgraded when located in a specific region of the chessboard, or when a specified quantity of virtual objects of the same type exist, a plurality of low-level virtual objects are merged and upgraded, to obtain a high-level virtual object. For example, two low-level virtual objects of the same type may be merged into one high-level virtual object.

Case 4: a description is made with reference to FIG. 10. In the operations in case 3, FIG. 10 is a schematic diagram of an exemplary virtual object display method according to an embodiment of the present disclosure. As shown in FIG. 10, a first virtual object 1002 is the first virtual object 902 shown in FIG. 9, and the first virtual object 1002 is placed into a chessboard bench region 1004 in the second virtual scene corresponding to the second account. If the first virtual object 1002 cannot be upgraded in the chessboard bench region 1004 of the second account, the first virtual object 1002 is placed as a virtual object in preparation into the chessboard bench region 1004 of the second account. The first virtual object 1002 moves to a chessboard battle region 1006 for battle only when the terminal detects that the second account sends an instruction instructing the first virtual object 1002 to participate in the battle. Alternatively, the terminal upgrades the first virtual object 1002 when determining that the first virtual object 1002 satisfies an upgrade condition. For example, when detecting that the second account has obtained another virtual object of the same type and the same level as the first virtual object 1002, the terminal may merge the virtual object with the first virtual object 1002, to obtain a higher-level first virtual object 1002. In this process, the target region is determined as a region in the chessboard battle region 1004.

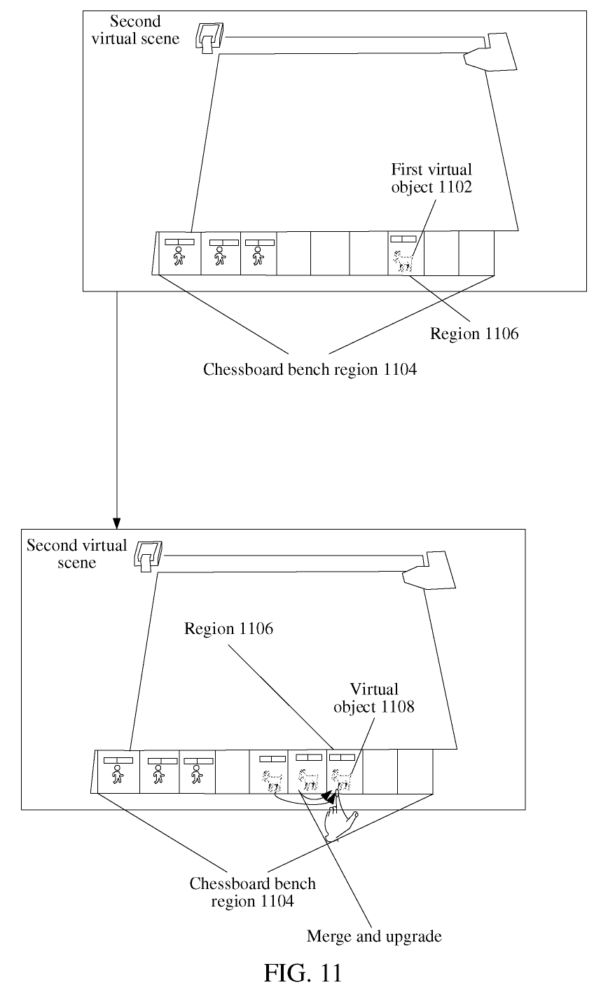

Case 5: a description is made with reference to FIG. 11. In the operations in case 3, FIG. 11 is a schematic diagram of an exemplary virtual object display method according to an embodiment of the present disclosure. As shown in FIG. 11, a first virtual object 1102 is the first virtual object 902 shown in FIG. 9, and the first virtual object 1102 is placed into a region 1106 of a chessboard bench region 1104 in the second virtual scene corresponding to the second account. When determining that the first virtual object 1102 satisfies the upgrade condition, the terminal performs an upgrade operation on the first virtual object 1102, to obtain a higher-level virtual object 1108, and places the virtual object 1108 into the region 1106. In this process, the target region is determined as the region 1106.

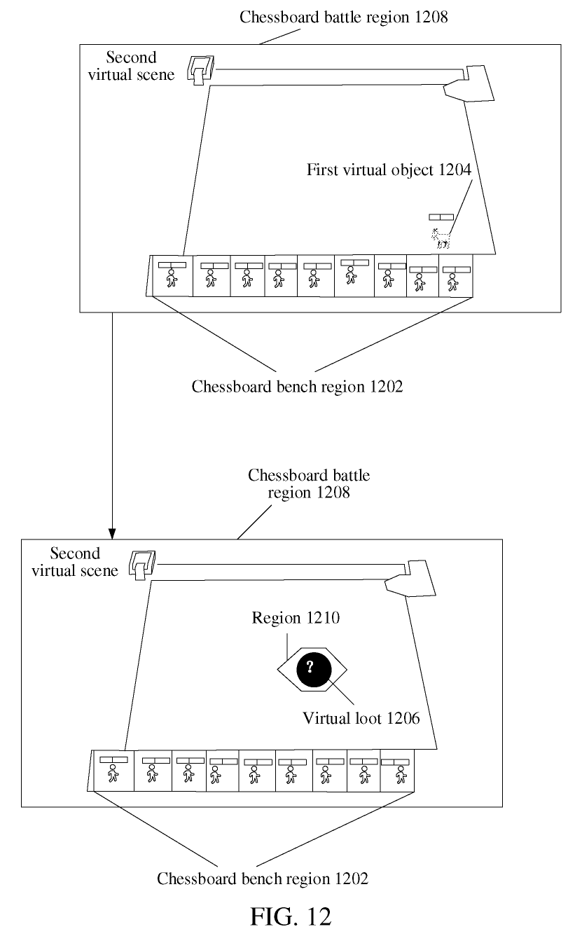

Case 6: a description is made with reference to FIG. 12. After the operations in case 5, FIG. 12 is a schematic diagram of an exemplary virtual object display method according to an embodiment of the present disclosure. As shown in FIG. 12, a quantity of virtual objects in a chessboard bench region 1202 in the second virtual scene corresponding to the second account has reached an upper limit, that is, no new virtual objects can be placed into the chessboard bench region 1202 of the second account. In this case, the electronic device transforms a first virtual object 1204 into a virtual loot 1206, and places the virtual loot 1206 into a region 1210 in a chessboard battle region 1208, for the second account to pick up the virtual loot 1206. In this process, the region 1210 in the chessboard battle region 1208 is the target region.

An upper quantity limit of virtual objects in the chessboard bench region 1202 of the second account may include, but is not limited to, being associated with an account level of the second account. For example, a higher account level of the second account indicates that more virtual objects can be placed into the chessboard bench region 1202 in a round of game, or regardless of the account level, in a round of game, the chessboard bench regions of a plurality of accounts can accommodate the same quantity of virtual objects.

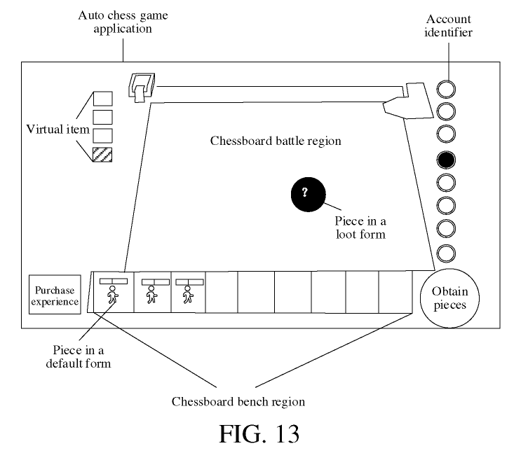

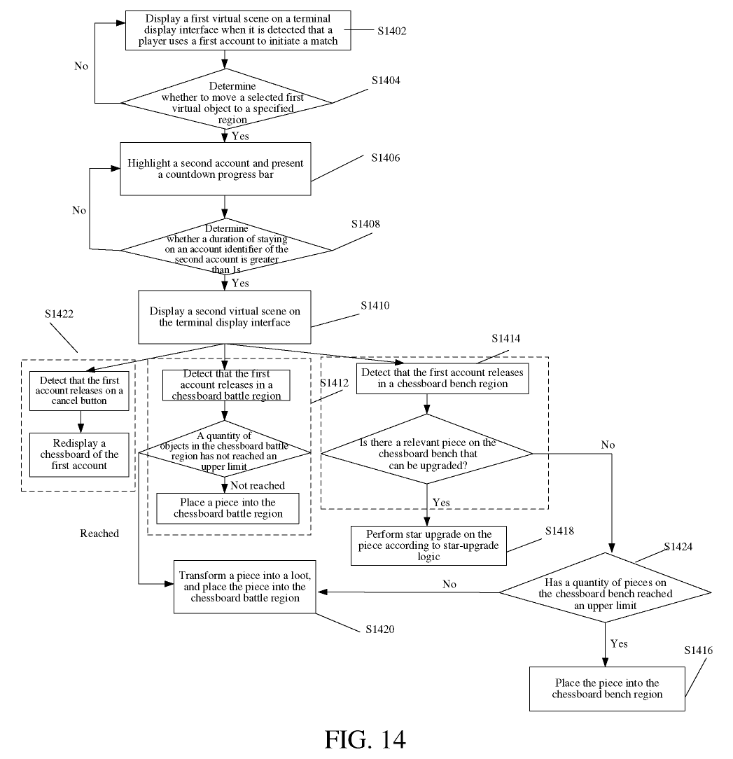

In an exemplary embodiment, FIG. 13 is a schematic diagram of an exemplary virtual object display method according to an embodiment of the present disclosure. The virtual object display method provided in the present disclosure may be applied to an auto chess game application. A display interface of the auto chess game application may be shown in FIG. 13. A player may use the first account to enter the auto chess game application, and choose to team up with the second account operated by another player, to play the game in a two-player mode of the game. FIG. 14 is a schematic diagram of an exemplary virtual object display method according to an embodiment of the present disclosure. The method is performed by a terminal. As shown in FIG. 14, the method includes, but is not limited to the following operations.

S1402: Display a first virtual scene on a terminal display interface when it is detected that a player uses a first account to initiate a match.

S1404: Determine whether to move a selected first virtual object to a specified region, and if yes, perform S1406; otherwise, perform S1402. The selection of the first virtual object in the first virtual scene may be implemented in the following manners, which may include, but are not limited to, long-pressing the first virtual object, tapping/clicking the first virtual object, double-tapping/clicking the first virtual object, and the like. A manner of moving the first virtual object to the specified region of the terminal display interface includes, but is not limited to, dragging the first virtual object with a finger to the specified region, or sending an instruction through voice input or a special gesture, to cause the virtual object to move to the specified region.

S1406: Highlight a second account and present a countdown progress bar. When an account identifier of the second account is highlighted, and the second account enters a ready state, the countdown progress bar is displayed in a specified region of the terminal display interface of the first account, to start the countdown. The specified region may include, but is not limited to, a right side, a left side, and the like of the terminal display interface. A duration of the countdown progress bar may be flexibly set. This is not limited in the present disclosure.

S1408: Determine whether a duration of staying on the account identifier of the second account is greater than 1s, and if yes, perform S1410; otherwise, perform S1406. When it is detected that the first account maintains an action of moving the first virtual object to an account identifier region of the second account on the terminal display interface, that is, when it is detected that the player moves the first virtual object to the account identifier of the second account without performing a next action, for example, dragging the first virtual object with a finger to the account identifier region of the second account without releasing it, and waiting for the end of the countdown progress bar (for example, waiting for one second), a chessboard of the second account is displayed, so that the player logged in to the first account can view the chessboard of the second account and information displayed on the terminal display interface of the second account.

S1410: Display a second virtual scene on the terminal display interface. The displaying the second virtual scene may include, but is not limited to, a subsequent action performed by the player on the first virtual object, for example, gifting the first virtual object to the second account, and selecting the first virtual object through touch screen input or the like, and dragging the first virtual object in the chessboard of the second account, that is, the first account drags the first virtual object to a region in a chessboard battle region of the second account. If a quantity of virtual objects in the chessboard battle region of the second account has not reached an upper quantity limit of virtual objects, the first virtual object is placed as a piece into a region in the chessboard battle region, where the virtual objects in the chessboard battle region may participate in a current battle. In other words, when there is still an available region in the chessboard battle region of the second account for placing a piece, if the terminal detects that the first account drags the first virtual object to a region in the chessboard battle region of the second account, after the first account releases it, the first virtual object is displayed in the available region in the chessboard battle region of the second account, so that the second virtual object can enter the current battle as a virtual object of the second account.

S1412: When it is detected that the first account releases in the chessboard battle region, and the quantity of virtual objects in the chessboard battle region has not reached an upper limit, place a piece into the chessboard battle region; or if the upper limit has been reached, perform S1420. More specifically, when detecting that the first account drags the first virtual object to a region in the chessboard battle region of the second account and the quantity of virtual objects in the chessboard battle region of the second account has reached the upper quantity limit of virtual objects, the terminal changes a form of the first virtual object. This may include, but is not limited to, transforming the first virtual object, which is originally in a form of a piece that may enter the current battle, into a form of a virtual loot that does not enter the current battle, and presenting the virtual loot in the chessboard battle region of the second account. The second account may pick up the first virtual object in the chessboard battle region in the following manners, including, but are not limited to, long-pressing the first virtual object, tapping/clicking the first virtual object, double-tapping/clicking the first virtual object, and the like. In other words, when the quantity of virtual objects in the chessboard battle region of the second account has reached the upper quantity limit of virtual objects and there is no available region for placing the first virtual object, if the terminal detects that the first account drags the first virtual object to the region in the chessboard battle region of the second account, after the first account releases it, the first virtual object is transformed into a display form that facilitates pickup by the second account.

S1414: When it is detected that the first account releases in a chessboard bench region, determine whether there is a relevant piece on the chessboard bench that can be upgraded, and if yes, perform S1418, or if not, perform S1424. The chessboard bench region of the second account may include, but is not limited to, a plurality of virtual objects. The virtual objects located in the chessboard bench region of the second account do not participate in the current battle. A virtual object enters the chessboard battle region for battle only when the second account sends an instruction instructing the virtual object to participate in the battle. The virtual objects located in the chessboard bench region of the second account may be upgraded. An upgrade manner may include, but is not limited to, the following: when a virtual object wins a battle, it obtains experience points, and after a quantity of experience points are accumulated, the virtual object is upgraded, to improve an attribute and a capability of the virtual object, or a level of the virtual object is directly increased by using a specific virtual item, or the virtual object is upgraded when located in a specific region of the chessboard, or when a specified quantity of virtual objects of the same type exist, a plurality of low-level virtual objects are merged and upgraded, to obtain a high-level virtual object. For example, two low-level virtual objects of the same type may be merged into one high-level virtual object.

S1416: Place the piece into the chessboard bench region. Assuming that the first virtual object is placed into the chessboard bench region of the second account, if the first virtual object cannot be upgraded in the chessboard bench region of the second account, the first virtual object may be placed into the chessboard bench region of the second account as a virtual object in preparation. The first virtual object is moved to the chessboard battle region for battle only when the second account sends an instruction instructing the first virtual object to participate in the battle. Alternatively, the first virtual object is upgraded when the first virtual object satisfies the upgrade condition, for example, the second account obtains another virtual object of the same type and the same level as the first virtual object, and the terminal may merge the virtual object with the first virtual object, to obtain a higher-level first virtual object.

S1418: Perform star upgrade on the piece according to star-upgrade logic. Assuming that the first virtual object is placed into the chessboard bench region of the second account, when the first virtual object satisfies the upgrade condition, the terminal upgrades the first virtual object, to obtain a higher-level virtual object, and places the virtual object into the chessboard bench region of the second account.

S1420: Transform the piece into a loot, and place the loot into the chessboard battle region. Assuming that the quantity of virtual objects in the chessboard bench region of the second account has reached the upper limit, that is, no new virtual object can be placed into the chessboard bench region of the second account, the terminal changes a form of the first virtual object, so that the first virtual object is changed into a virtual loot that can be placed into the chessboard battle region and picked up by the second account.

S1422: Redisplay a chessboard of the first account when it is detected that the first account releases on a cancel button, to cancel the display of the chessboard of the second account, and redisplay the first virtual scene of the first account on the terminal display interface, where the operation includes, but is not limited to, dragging the first virtual object to the cancel button on the terminal display interface and performing a release operation.

S1424. Determine whether a quantity of pieces on the chessboard bench has reached an upper limit, and if yes, perform S1416; or if not, perform S1420.

The upgrade in the foregoing process may be completed by the terminal. For example, the terminal determines, according to upgrade logic of the game application (for example, whether obtained experience points have reached a condition, or whether a task progress has reached a condition), whether the first virtual object can be upgraded. When the first virtual object can be upgraded, the terminal calculates new attribute data, such as a maximum health point and a skill level, for the first virtual object to perform upgrade. The upgrade in the foregoing process may alternatively be completed by the terminal and the server in cooperation. For example, the terminal may add level-related data (such as experience points and a task progress) of the first virtual object to an upgrade request at regular intervals, and report the upgrade request to the server. The server parses the level-related data, determines whether the level-related data satisfies the upgrade condition, and when the level-related data satisfies the upgrade condition, recalculates latest attribute data, such as a maximum health point and a skill level, for the first virtual object, and delivers the latest attribute data to the terminal. The terminal updates the attribute data of the first virtual object based on the attribute data, to complete upgrade.

Similarly, the changing the form of the first virtual object into the virtual loot in the foregoing process may be completed by the terminal, or may be completed by the terminal and the server in cooperation. For example, the terminal may use stored data of the virtual loot render the virtual loot, and display the virtual loot, to complete form transformation; or obtain data of the virtual loot from the server through a data request, and render and display the virtual loot, to complete form transformation.

In another exemplary embodiment, the virtual object display method provided in the present disclosure may further be applied to a cloud drive application, and includes, but is not limited to, the following operations.

S1: Display a first cloud drive scene on a terminal display interface when it is detected that the user uses the first account to enter a cloud drive application and choose to transmit a file to the second account. In the first cloud drive scene, the file is selected when the following operations are detected, which may include, but are not limited to, long-pressing the file, tapping/clicking the file, double-tapping/clicking the file, and the like. When the file is selected, the terminal moves the file to a specified region on the terminal display interface when the following operation is detected, which includes, but is not limited to, dragging the file with a finger to the specified region, or sending an instruction through voice input or a special gesture, so that the file is moved to the specified region.

S2: When an account identifier region of the second account is highlighted, and the second account enters a ready state, display a countdown progress bar in a specified region of the terminal display interface of the first account, to start the countdown. The specified region may include, but is not limited to, a right side, a left side, and the like of the terminal display interface. A duration of the countdown progress bar may be flexibly set. This is not limited in the present disclosure.

S3: Display a second cloud drive scene of the second account when it is detected that the first account maintains the action of moving the file to the account identifier region of the second account on the terminal display interface. In other words, when it is detected that the user moves the file to the account identifier of the second account without performing a next action, for example, dragging the file to the account identifier region of the second account without releasing it, and waiting for the end of the countdown progress bar (for example, waiting for one second), a display surface of the second account is displayed, so that the user logged in to the first account can view a cloud drive storage space of the second account and information displayed on the terminal display interface of the second account.

S4: Display the second cloud drive scene on the terminal display interface, which may include, but is not limited to, a subsequent action performed by the user on the file, for example, transmitting a file to the second account and selecting the file through touchscreen input and dragging the file in the cloud drive storage space of the second account, that is, the first account drags the file to a region in a local storage space region of the second account. If a quantity of files in the local storage space region of the second account has not reached an upper quantity limit of files, the file is placed into a region in the local storage region. That is, when there is still an available region in the local storage space region of the second account for placing a file, if the terminal detects that the first account drags the file to the region in the local storage space region of the second account, after the first account releases it, the file is displayed in the available region of the local storage space region of the second account, so that the file can be used as a file stored locally by the second account.

S5: When it is detected that the first account drags the file to the region in the local storage space region of the second account, and the quantity of files in the local storage space region of the second account has reached the upper quantity limit of files, the terminal changes a form of the file, which may include, but is not limited to, transforming the file, which is originally in a voice form, into a text form in the local storage space region of the second account. The second account may obtain the file in a temporary storage space region in the following manners, which include, but are not limited to, long-pressing the file, tapping/clicking the file, double-tapping/clicking the file, and the like. For example, when the quantity of files in the voice form in the local storage space region of the second account has reached the upper quantity limit of files, and there is no available region for placing the file in the voice form, if the terminal detects that the first account drags the file in the voice form to a region in the local storage space region of the second account, after the first account releases it, the file in the voice form is automatically changed into the text form, and after the file is obtained by the second account, the file is automatically organized in the local storage space.

S6: Detect whether the first account drags a file to a cloud storage space region of the second account. The cloud storage space region of the second account may include, but is not limited to, a plurality of files. Assuming that the files are of the same type, that is, a plurality of small files may be combined into one large file, a merge and upgrade operation may be performed on the files.

S7: In operation S6, assuming that the file is to be placed into the cloud storage space region of the second account, if the file cannot be upgraded in the cloud storage space region of the second account, the file may be placed into the cloud storage space region of the second account as a backup file. The file is moved to the local storage space region only when the second account needs to use the file. Alternatively, the file is upgraded when the file satisfies the upgrade condition, for example, the second account obtains another file of the same type and the same level as the file, and the terminal may merge the files, to obtain a new file.

S8: In operation S6, assuming that the file is to be placed into the cloud storage space region of the second account, if the file satisfies the upgrade condition, the terminal upgrades the file, to obtain a higher-level file D, and places the file D into the cloud storage space region of the second account.

S9: In operation S6, assuming that a quantity of files in the cloud storage space region of the second account has reached an upper limit, that is, no new file can be placed into the cloud storage space region of the second account, the terminal changes a form of the file, so that the file can be placed into the local storage space region and obtained by the second account.

S10: After displaying the cloud drive storage space of the second account, the terminal may further cancel the display of the cloud drive storage space of the second account and redisplay the first cloud drive scene of the first account on the terminal display interface when detecting the following operations. The operations include, but are not limited to, dragging the file to the cancel button on the terminal display interface and releasing it, that is, canceling the action of transmitting the file to the second account and returning to the first cloud drive scene.

According to this embodiment of the present disclosure, a first virtual scene corresponding to a first account in a current match is displayed, where accounts participating in the current match include a group of accounts, the group of accounts includes the first account, and the first virtual scene displays a group of virtual objects owned by the first account; a second virtual scene corresponding to a second account and a first virtual object are displayed in response to a first interaction operation performed by the first account in the first virtual scene, where the first interaction operation is an operation of determining the first virtual object from the group of virtual objects and determining the second account from accounts in the group of accounts other than the first account; and a first virtual object is displayed in a target region in the second virtual scene in response to a second interaction operation performed by the first account in the second virtual scene, where the second interaction operation is an operation of determining the target region from the second virtual scene, and the display of the first virtual object in the target region indicates that the first virtual object is owned by the second account. The first account performs the first interaction operation, so that at least one of the virtual objects owned can be determined as the first virtual object in the first virtual scene, and the second virtual scene corresponding to the second account is displayed through the first interaction operation. The first account performs the second interaction operation, so that the first virtual object can be displayed in the second virtual scene. In this way, the first account can assist the second account, to operate and process the first virtual object shared by the first account, thereby improving the processing efficiency of the virtual object. This resolves a technical problem of low processing efficiency of the virtual object after the transfer of the virtual object, which is caused by the complexity of communication between accounts.

In addition, the first account can quickly determine the target region through the second interaction operation in the second virtual scene. After the target region is determined, the first virtual object can be automatically placed into the target region, so that the first account assists the second account in processing the first virtual object. In other words, by using the virtual object display method provided in the present disclosure, decision-making pressure of the second account when receiving the first virtual object can be reduced, thereby simplifying an operation process of the second account for the first virtual object, and improving gaming experience.

In an implementation, the second interaction operation includes: controlling the first virtual object to move to the target region, and the displaying the first virtual object in a target region in the second virtual scene in response to a second interaction operation performed by the first account in the second virtual scene includes: determining a first comparison relationship between a quantity of virtual objects deployed in the target region and a first upper quantity limit in response to the first account controlling the first virtual object to move to the target region in the second virtual scene; and displaying the first virtual object in the target region when the first comparison relationship indicates that the quantity of virtual objects deployed in the target region has not reached the first upper quantity limit.

The target region may be a first region, or may be a second region. The first region is configured for deploying virtual objects that the second account needs to use in a next round of the current match. The second region is configured for deploying virtual objects that the second account does not need to use in the next round of the current match and that are owned by the second account. The current match includes a plurality of rounds, and the first region is a region configured for deploying virtual objects participating in a battle in each round. Therefore, the virtual objects located in the first region are used for battle at the start of each round, and the virtual objects may be redeployed in the first region at the end of each round. The next round of the current match is a next round of a completed round in the current match.

In other words, the terminal displays the first virtual object in the first region in response to the first account controlling the first virtual object to the first region in the second virtual scene, and when the quantity of virtual objects deployed in the first region has not reached the upper quantity limit of the first region (that is, a value of the first upper quantity limit when the target region is the first region).

Similarly, the terminal displays the first virtual object in the second region in response to the first account controlling the first virtual object to the second region in the second virtual scene, and when the quantity of virtual objects deployed in the second region has not reached the upper quantity limit of the second region (that is, the value of the first upper quantity limit when the target region is the second region).

In this embodiment of the present disclosure, the first region and the second region may be understood as two different regions in the second virtual scene. Both the first region and the second region may include, but are not limited to, virtual objects. The virtual objects in the first region may be used as virtual objects that can be deployed in a next round of a current round of the current match. The virtual objects in the second region are virtual objects already owned by the second account and may not be deployed in the next round of the current round. In other words, the virtual objects in the second region may be understood as backup virtual objects. A virtual object in the second region is placed into the first region only when the terminal detects that the second account selects the virtual object and sends a deployment instruction, indicating that the virtual object can be deployed.

For example, the first virtual object may be moved to the first region in the second virtual scene when the terminal detects the following operations of the first account. The operations include, but are not limited to, touchscreen input, voice input, and the like. It is assumed that N virtual objects exist in the first region, and the upper quantity limit of the first region is determined to be M (where N and M are both positive integers) based on factors such as game restrictions or a level restriction of the second account. If N is less than M, the first region can accommodate a new virtual object. In other words, in this case, the first virtual object may be placed into the first region as a virtual object that the second account needs to use in the next round.

For another example, the first virtual object may be moved to the second region in the second virtual scene when the terminal detects the following operations of the first account. The operations include, but are not limited to, touchscreen input, voice input, and the like. It is assumed that P virtual objects exist in the second region, and the upper quantity limit of the second region is determined to be Q (where P and Q are both positive integers) based on factors such as game restrictions or a level restriction of the second account. If P is less than Q, it indicates that the second region can accommodate a new virtual object, so that the first virtual object may be placed into the second region as a virtual object already owned by the second account in the current match. When obtaining a deployment instruction sent by the second account, the first virtual object enters the first region. For example, the second account drags the first virtual object in the second region with a finger to the first region.

According to this embodiment of the present disclosure, in the second virtual scene, the first account moves the first virtual object to the target region, determines, based on the first upper quantity limit of the target region, whether the target region can accommodate the first virtual object, and if the first virtual object can be accommodated, the first account places the first virtual object into the corresponding region, so that the first account assists the second account in managing virtual objects, thereby achieving the technical effect of shortening the processing time of the first virtual object in the second virtual scene.

In an implementation, after the determining a first comparison relationship between a quantity of virtual objects deployed in the target region and a first upper quantity limit in response to the first account controlling the first virtual object to move to the target region in the second virtual scene, the method further includes: when the first comparison relationship indicates that the quantity of virtual objects deployed in the target region has reached the first upper quantity limit, performing one of the following processing:

displaying a virtual object identifier in the target region, where the virtual object identifier is configured for indicating that the first account has transferred the first virtual object to the second account, and that the quantity of virtual objects deployed in the target region has reached the first upper quantity limit;

determining a second comparison relationship between a quantity of virtual objects deployed in an alternate region corresponding to the target region and a second upper quantity limit, and displaying the first virtual object in the alternate region when the second comparison relationship indicates that the quantity of virtual objects deployed in the alternate region has not reached the second upper quantity limit; or

canceling the display of the second virtual scene, and displaying the first virtual scene.

When the target region includes the first region, the alternate region includes the second region, and the first upper quantity limit includes the upper quantity limit of the first region. When the target region includes the second region, the alternate region includes the first region, and the first upper quantity limit includes the upper quantity limit of the second region. That is, the first region and the second region are alternate regions for each other. The alternate region is a backup region that can be used for placing virtual objects when the target region can no longer accommodate virtual objects.

In other words, when the target region is the first region, the terminal displays a first virtual object identifier in the first region in response to the first account controlling the first virtual object to move to the first region, and when the quantity of virtual objects deployed in the first region has reached the upper quantity limit of the first region. The first virtual object identifier is configured for indicating that the first account has transferred the first virtual object to the second account, and that the quantity of virtual objects deployed in the first region has reached the upper quantity limit of the first region. Alternatively, the terminal displays the first virtual object in the second region in response to the first account controlling the first virtual object to move to the first region, and when the quantity of virtual objects deployed in the first region has reached the upper quantity limit of the first region, and the quantity of virtual objects deployed in the second region has not reached the upper quantity limit of the second region (that is, a value of the second upper quantity limit when the target region is the first region). Alternatively, the terminal cancels the display of the second virtual scene and displays the first virtual scene in response to the first account controlling the first virtual object to move to the first region, and when the quantity of virtual objects deployed in the first region has reached the upper quantity limit of the first region.

The first virtual object identifier may be understood as another representation form of the first virtual object in the second virtual scene. When the first virtual object is moved by the first account to the first region in the second virtual scene, and the first region cannot accommodate a new virtual object, the terminal displays the first virtual object identifier in the first virtual scene instead of displaying the first virtual object. For example, if the first virtual object is a game character, the first virtual object identifier may be in a loot form of the game character.

For example, the upper quantity limit of the first region may be equal to the quantity of virtual objects already existing in the current first region, that is, the first region cannot accommodate a new virtual object. In this case, the first virtual object may be transformed into a virtual loot form. As shown in FIG. 8, the first virtual object 802 is changed into the virtual loot 808. The virtual loot 808 is still displayed in the first region and may be obtained by the second account.

In some embodiments, when the first region cannot accommodate a new virtual object, if the upper quantity limit of the second region is greater than the quantity of virtual objects already existing in the current second region, that is, the second region can accommodate a new virtual object, the first virtual object may alternatively be displayed in the second region. In other words, when detecting that the first account places the first virtual object into the first region that cannot accommodate a new virtual object, the terminal automatically displays the first virtual object in the second region.

In addition, when the first region cannot accommodate a new virtual object, the display of the second virtual scene may further be canceled, and the first virtual scene is displayed. In this case, the first virtual object is no longer displayed in the second virtual scene, and the virtual object appears in the first virtual scene. For example, when the first account finds that the first region cannot accommodate a new virtual object, the first virtual object may be dragged, through touchscreen input or the like, to a cancel control in the second virtual scene displayed on the terminal display interface, to indicate cancellation of the display of the second virtual scene. In this case, the terminal display interface no longer displays the second virtual scene but displays the first virtual scene instead.

According to this embodiment of the present disclosure, when the target region is the first region, and the quantity of virtual objects included in the first region has reached the corresponding upper quantity limit of the first region, three different display manners are provided for the first virtual object: displaying the first virtual object identifier in the first region, displaying the first virtual object in the second region, or canceling the display of the first virtual object in the second virtual scene and displaying the first virtual object in the first virtual scene. This expands the display method for the first virtual object, thereby improving quality of gameplay and interactive experience.

When the target region is the second region, the terminal displays the first virtual object identifier in the second region (certainly, the first virtual object identifier may alternatively be displayed in the first region) in response to the first account controlling the first virtual object to move to the second region, and when the quantity of virtual objects deployed in the second region has reached the upper quantity limit of the second region. The first virtual object identifier is configured for indicating that the first account has transferred the first virtual object to the second account, and that the quantity of virtual objects deployed in the second region has reached the upper quantity limit of the second region. The terminal displays the first virtual object in the first region in response to the first account controlling the first virtual object to move to the second region, and when the quantity of virtual objects deployed in the second region has reached the upper quantity limit of the second region, and the quantity of virtual objects deployed in the first region has not reached the upper quantity limit of the first region (that is, a value of the second upper quantity limit when the target region is the second region). Alternatively, the terminal cancels the display of the second virtual scene and displays the first virtual scene in response to the first account controlling the first virtual object to move to the second region, and when the quantity of virtual objects deployed in the second region has reached the upper quantity limit of the second region.

For example, the upper quantity limit of the second region may be equal to the quantity of virtual objects already existing in the current second region, that is, the second region cannot accommodate a new virtual object. In this case, the first virtual object may be transformed into a loot form. As shown in FIG. 12, the first virtual object 1204 is changed into the virtual loot 1206. The virtual loot 1206 is displayed in the first region.

In some embodiments, when the second region cannot accommodate a new virtual object, if the upper quantity limit of the first region is greater than the quantity of virtual objects already existing in the current first region, that is, the first region can accommodate a new virtual object, the second virtual object may alternatively be displayed in the first region. In other words, when detecting that the first account places the second virtual object into the second region that cannot accommodate a new virtual object, the terminal automatically displays the second virtual object in the first region.

In addition, when the second region cannot accommodate a new virtual object, the display of the second virtual scene may further be canceled, and the first virtual scene is displayed. In this case, the first virtual object is no longer displayed in the second virtual scene, and the virtual object appears in the first virtual scene. For example, when the first account finds that the second region cannot accommodate a new virtual object, the first virtual object may be dragged, through touchscreen input or the like, to a cancel control in the second virtual scene displayed on the terminal display interface, to indicate cancellation of the display of the second virtual scene. In this case, the terminal display interface no longer displays the second virtual scene but displays the first virtual scene instead.

According to this embodiment of the present disclosure, when the target region is the second region, and the quantity of virtual objects included in the second region has reached the corresponding upper quantity limit of the second region, three different display manners are provided for the first virtual object: displaying the first virtual object identifier in the second region, displaying the first virtual object in the first region, or canceling the display of the first virtual object in the second virtual scene and displaying the first virtual object in the first virtual scene. This expands the display method for the first virtual object, thereby improving visual performance of the game.

In an implementation, the second interaction operation includes: controlling the first virtual object to move to the target region. In this case, in response to the second interaction operation performed by the first account in the second virtual scene, the method further includes: displaying, in response to the first account controlling the first virtual object to move to the target region, and when the target region displays a second virtual object, a third virtual object in the target region, and canceling the display of the second virtual object, the second virtual object being allowed to be merged with the first virtual object into the third virtual object; and selecting, in response to the first account controlling the first virtual object to move to the target region, and when an alternate region corresponding to the target region displays the second virtual object, one of the target region and the alternate region to display the third virtual object, and canceling the display of the second virtual object.

More specifically, when the target region is the second region, and the alternate region is the first region, in response to the first account controlling the first virtual object to move to the second region, and when the second region displays the second virtual object, the terminal displays the third virtual object in the second region and cancels the display of the second virtual object. When the target region is the first region, and the alternate region is the second region, in response to the first account controlling the first virtual object to move to the first region, and when the first region displays the second virtual object, the terminal displays the third virtual object in the first region and cancels the display of the second virtual object.

When the target region is the first region, and the alternate region is the second region, in response to the first account controlling the first virtual object to move to the first region, and the second region displays the second virtual object, the terminal displays the third virtual object in the first region or the second region and cancels the display of the second virtual object. When the target region is the second region, and the alternate region is the first region, in response to the first account controlling the first virtual object to move to the second region, and when the first region displays the second virtual object, the terminal displays the third virtual object in the first region or the second region and cancels the display of the second virtual object.

For example, the second virtual object may be understood as a virtual object in the second virtual scene before the first account moves the first virtual object to the second virtual scene, that is, a virtual object already owned by the second account in the current match. The second virtual object and the first virtual object may have same information such as a type and a level, and the second virtual object may include one or more virtual objects. The third virtual object may be understood as a virtual object obtained by performing a merge operation on the first virtual object and another virtual object.

For example, if the first virtual object is a game character, before the first account moves the first virtual object to the second region, two game characters of the same type and the same level as the first virtual object, that is, the second virtual objects, already exist in the second region. In this case, the merge operation may be performed on the second virtual object and the first virtual object, to obtain the third virtual object. The third virtual object is also a game character of the same type as the first virtual object, and the third virtual object may have a level higher than that of the first virtual object and the second virtual object. After the merge operation is performed on the second virtual object and the first virtual object, the second region no longer displays the second virtual object but displays the third virtual object instead.

For another example, if the first virtual object is a game character, before the first account moves the first virtual object to the first region, one game character of the same type and the same level as the first virtual object, that is, the second virtual object, already exists in the first region. In this case, the merge operation may be performed on the second virtual object and the first virtual object, to obtain the third virtual object. The third virtual object is also a game character of the same type as the first virtual object, and the third virtual object may have a level higher than that of the first virtual object and the second virtual object. After the merge operation is performed on the second virtual object and the first virtual object, the first region no longer displays the second virtual object but displays the third virtual object instead.

For another example, if before the first account moves the first virtual object to the first region, three game characters of the same type and the same level as the first virtual object, that is, the second virtual objects, already exist in the second region, the merge operation may be performed on the second virtual object and the first virtual object, to obtain the third virtual object, and after the merge operation is performed on the second virtual object and the first virtual object, the first region no longer displays the second virtual object but displays the third virtual object instead. Similarly, if before the first account moves the first virtual object to the second region, four game characters of the same type and the same level as the first virtual object that is, the second virtual objects, already exist in the first region, the merge operation may be performed on the second virtual object and the first virtual object, to obtain the third virtual object. After the merge operation is performed on the second virtual object and the first virtual object, the second region no longer displays the second virtual object but displays the third virtual object instead.

For example, when the first account moves the first virtual object to the first region, the terminal may merge the first virtual object with the second virtual object in the first region, or with the second virtual object in the second region, to obtain the third virtual object, and then cancel the display of the second virtual object while displaying the third virtual object in the first region. When the first account moves the first virtual object to the second region, the terminal may merge the first virtual object with the second virtual object in the first region or with the second virtual object in the second region, to obtain the third virtual object, and cancel the display of the second virtual object while displaying the third virtual object in the second region. In addition, in this embodiment of the present disclosure, a region area occupied by each virtual object may vary. For example, a region area occupied by the first virtual object may be less than a region area occupied by the third virtual object. It is assumed that the third virtual object obtained by merging the first virtual object and the second virtual object needs to occupy a region area A, and both the first virtual object and the second virtual object need to occupy a region area B (where the region area B is smaller than the region area A). In this case, if a current region area of the first region that can accommodate virtual objects is the region area B, and a current region area of the second region that can accommodate virtual objects is a region area C, where the region area C is greater than or equal to the region area A, that is, when the first region cannot accommodate the third virtual object but the second region can accommodate the third virtual object, the terminal automatically selects the second region to display the third virtual object.

According to this embodiment of the present disclosure, when the second virtual object exists in the second virtual scene, the merge operation may be performed on the second virtual object and the first virtual object, to obtain the third virtual object. The third virtual object may be displayed in the first region or may be displayed in the second region, enabling a rapid merge of the first virtual object to obtain the third virtual object of the same type as the first virtual object but with a higher level, thereby providing a richer gaming experience for the second account. In addition, the second virtual object and the first virtual object are automatically merged, thereby improving the rate at which the second account obtains the third virtual object.

In an implementation, the selecting, in response to the first account controlling the first virtual object to move to the target region, and when an alternate region corresponding to the target region displays the second virtual object, one of the target region and the alternate region to display the third virtual object include: displaying the third virtual object in the alternate region in response to the first account controlling the first virtual object to move to the target region, and when the alternate region displays the second virtual object, and a quantity of virtual objects deployed in the target region has reached a first upper quantity limit; or displaying the third virtual object in the target region in response to the first account controlling the first virtual object to move to the target region, and when the alternate region displays the second virtual object, and a quantity of virtual objects deployed in the target region has not reached a first upper quantity limit.

When the target region is the first region, and the alternate region is the second region, the terminal displays the third virtual object in the second region in response to the first account controlling the first virtual object to move to the first region, and when the second region displays the second virtual object, and the quantity of virtual objects deployed in the first region has reached the upper quantity limit of the first region; or displays the third virtual object in the first region in response to the first account controlling the first virtual object to move to the first region, and when the second region displays the second virtual object, and the quantity of virtual objects deployed in the first region has not reached the upper quantity limit of the first region.

When the target region is the second region, and the alternate region is the first region, the terminal displays the third virtual object in the first region in response to the first account controlling the first virtual object to move to the second region, and when the first region displays the second virtual object, and the quantity of virtual objects deployed in the second region has reached the upper quantity limit of the second region; or displays the third virtual object in the second region in response to the first account controls the first virtual object to move to the second region, and when the first region displays the second virtual object, and the quantity of virtual objects deployed in the second region has not reached the upper quantity limit of the second region.

For example, when the first account moves the first virtual object to the first region, and the quantity of virtual objects in the first region has reached the upper quantity limit of the first region, that is, the first region cannot accommodate a new virtual object, the third virtual object generated by merging the first virtual object and the second virtual object in the second region may be displayed in the second region, and the second virtual object is no longer displayed in the second region. When the first account moves the first virtual object to the first region, and the quantity of virtual objects in the first region has not reached the upper quantity limit of the first region, that is, the first region can accommodate a new virtual object, the third virtual object generated by merging the first virtual object and the second virtual object in the second region may be displayed in the first region, and the second virtual object is no longer displayed in the first region.

In an implementation, the second interaction operation includes: controlling the first virtual object to move to a cancel control, so that the processing performed by the terminal in response to the second interaction operation performed by the first account in the second virtual scene further includes the following processing: canceling the display of the second virtual scene in response to the first account controlling the first virtual object to move to the cancel control, displaying the first virtual scene, and displaying the first virtual object in the first virtual scene. The cancel control is a control for canceling the transfer of the first virtual object to the second account.

The cancel control may be arranged in a third region of the second virtual scene. In other words, the terminal may, in response to the first account controlling the first virtual object to move to the cancel control arranged in the third region, exit the second virtual scene and redisplay the first virtual scene.

In an implementation, the first virtual object is controlled to move to a fourth region, so that the processing performed by the terminal in response to the second interaction operation performed by the first account in the second virtual scene further includes the following processing: displaying the first virtual object in the fourth region in response to the first account controlling, in the second virtual scene, the first virtual object to move to the fourth region. The movement of the first virtual object to the fourth region indicates that the first account allows the second account to use the first virtual object, which is transferred from the first account to the second account, in a next round of the current match.

In this embodiment of the present disclosure, the third region may be understood as a region in the second virtual scene, and the fourth region may be understood as a region in the second virtual scene. The third region and the fourth region may partially overlap with the first region and the second region. A positional relationship between the first region, the second region, the third region, and the fourth region is not limited in the present disclosure.

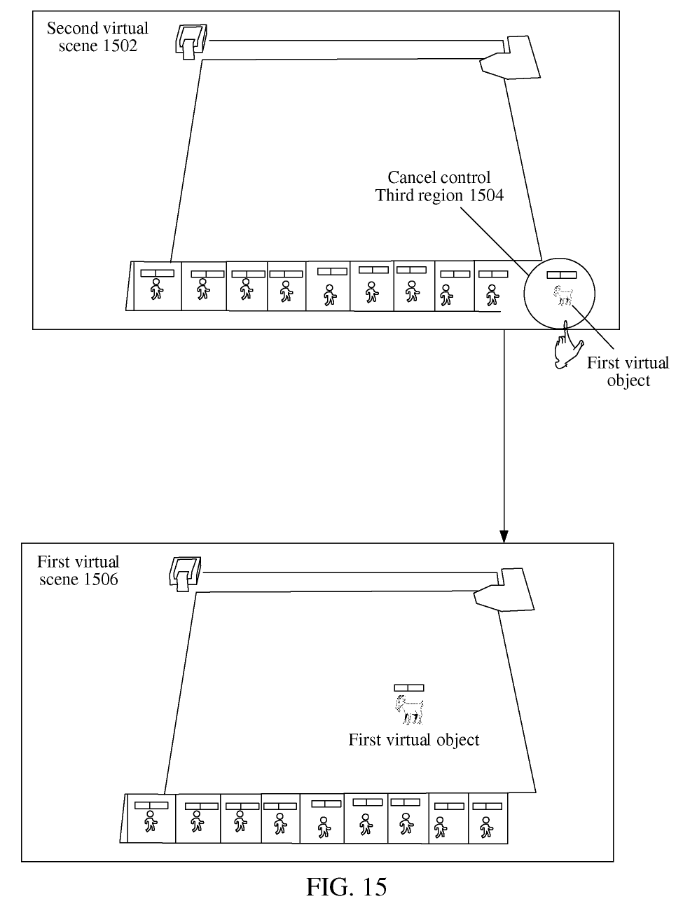

For example, FIG. 15 is a schematic diagram of another exemplary virtual object display method according to an embodiment of the present disclosure. As shown in FIG. 15, if the first account moves a first virtual object in a second virtual scene 1502 to a third region 1504, where the third region 1504 includes a cancel control, the terminal display interface of the first account no longer displays the second virtual scene 1502 but displays a first virtual scene 1506 associated with the first account instead. That is, when the first virtual object is displayed in the third region 1504, it indicates a switch of a game picture on the terminal display interface of the first account, changing the second virtual scene 1502 to the first virtual scene 1506. In addition, if the first account moves the first virtual object in the second virtual scene to a fourth region, the first virtual object may not be used in a current round of a current match, and the first virtual object is used in a next round of the current match. In other words, displaying the first virtual object in the fourth region indicates that the first virtual object is one of the virtual objects owned by the second account in the next round of the current match.

According to this embodiment of the present disclosure, the first virtual object is displayed in the third region when display of the first virtual object in the second virtual scene needs to be canceled, or the first virtual object is displayed in the fourth region when the first virtual object is used in the next round of the current match. This expands the display method for the first virtual object, thereby improving quality of gameplay and interactive experience of the game.

In an implementation, the first interaction operation may include: an object selection sub-operation and an account selection sub-operation, so that the displaying a second virtual scene corresponding to a second account and a first virtual object in response to a first interaction operation performed by the first account in the first virtual scene includes: determining the first virtual object from the group of virtual objects in response to the object selection sub-operation, and displaying a virtual object identifier of the first virtual object, where the virtual object identifier is allowed to be controlled to move; moving the virtual object identifier to a target account identifier in response to the account selection sub-operation, and determining an account in the group of accounts that corresponds to the target account identifier as the second account; and displaying the corresponding second virtual scene in response to the second account being determined, and displaying the first virtual object in the second virtual scene.

In this embodiment of the present disclosure, the virtual object identifier may be configured for representing the first virtual object, and the virtual object identifier is movable. In other words, the first account may move the virtual object identifier through touchscreen input and the like. The movement of the virtual object identifier indicates a change in the region in which the first virtual object is located. The first account may determine the first virtual object from a group of virtual objects, and use the virtual object identifier to represent the first virtual object in the first virtual scene and the second virtual scene. The object selection sub-operation is an operation of selecting a virtual object by the first account from a group of virtual objects. The virtual object selected through the object selection sub-operation is the first virtual object. The account selection sub-operation is an operation of selecting an account from a group of accounts. The account selected through the account selection sub-operation is the second account.

The target account identifier may be configured for representing the second account. The first account may move the virtual object identifier to an account identifier through the account selection sub-operation. The account identifier is the target account identifier. In this way, the second account may be determined by using the target account identifier. After the second account is determined, the terminal display interface of the first account no longer displays the first virtual scene but displays the second virtual scene instead. In this case, the first virtual object appears in the second virtual scene. The account selection sub-operation may be implemented as a drag operation performed on the virtual object identifier.

According to this embodiment of the present disclosure, the virtual object identifier is used to represent the first virtual object, and the virtual object identifier is moved to the target account identifier, to determine the second account that obtains the first virtual object. This can quickly determine the second account, thereby achieving the technical effect of improving display efficiency of the second virtual scene.

In an implementation solution, the object selection sub-operation includes: a first operation or a second operation. In this case, the determining the first virtual object from the group of virtual objects in response to the object selection sub-operation, and displaying a virtual object identifier of the first virtual object includes one of the following processing: determining, in response to the first operation of selecting a virtual object in the group of virtual objects, the virtual object corresponding to the first operation as the first virtual object, and displaying the virtual object identifier; or determining, in response to the second operation of applying a target virtual item to a virtual object in the group of virtual objects, the virtual object to which the target virtual item is applied as the first virtual object, and displaying the virtual object identifier, where the target virtual item is configured for transferring virtual objects between different accounts.

In this embodiment of the present disclosure, the first operation and the second operation may include, but are not limited to, a touch operation performed on a touchscreen, or a touch operation performed through an input device such as a mouse, a keyboard, or a stylus. The target virtual item may be understood as a virtual resource owned by the first account. The target virtual item may transfer a virtual object owned by an account to another account, for example, a rune item. The target virtual item may be configured for enhancing an attribute of a virtual object, which may be understood as that a virtual object equipped with the target virtual item has a stronger capability than a virtual object not equipped with the target virtual item. Assuming that the virtual object is a warrior, a movement speed of the virtual object equipped with the target virtual item may be faster than a movement speed of the virtual object not equipped with the target virtual item.

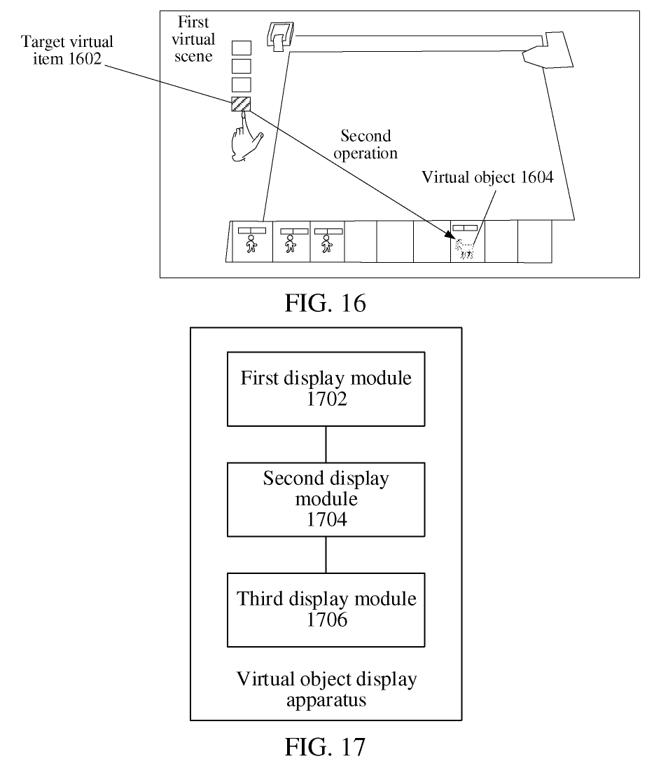

For example, after the first account performs the first operation on one virtual object in the groups of virtual objects, the virtual object is determined as the first virtual object. In this case, the virtual object identifier corresponding to the first virtual object is displayed in the first virtual scene. For another example, FIG. 16 is a schematic diagram of another exemplary virtual object display method according to an embodiment of the present disclosure. As shown in FIG. 16, the second operation is performed on a target virtual item 1602. For example, after the target virtual item 1602 is selected through touchscreen input, the target virtual item 1602 is dragged to a virtual object 1604 in the group of virtual objects, and the target virtual item 1602 is applied to the virtual object 1604, so that the virtual object 1604 is determined as the first virtual object.

In an implementation, the determining an account in the group of accounts that corresponds to the target account identifier as the second account includes: determining an account in the group of accounts that corresponds to the target account identifier as the second account when a duration for which the virtual object identifier stays on the target account identifier satisfies a duration condition.

For example, the account selection sub-operation may include, but is not limited to, a touch operation performed on a touchscreen, or a touch operation performed through an input device such as a mouse, a keyboard, or a stylus. For example, the virtual object identifier is moved to one account identifier of a group of account identifiers through touchscreen input. The account identifier is the target account identifier.

After being moved to the target account identifier by dragging, the virtual object identifier may stay on the target account identifier for a period of time. The duration condition may be understood as a preset stay duration of the virtual object identifier. For example, when a duration for which the virtual object identifier stays on an account identifier is greater than or equal to one second, it is considered that the duration for which the virtual object identifier stays on the target account identifier satisfies the duration condition, and the account identifier is determined as the target account identifier. If the duration for which the virtual object identifier stays on an account identifier is less than one second, it is considered that the duration for which the virtual object identifier stays on the target account identifier does not satisfy the duration condition.

In an implementation, after the moving the virtual object identifier to a target account identifier in response to the account selection sub-operation, and before the determining an account in the group of accounts that corresponds to the target account identifier as the second account when a duration for which the virtual object identifier stays on the target account identifier satisfies a duration condition, the method further includes: highlighting the target account identifier, and displaying a timer corresponding to the target account identifier.

In this case, the determining the account in the group of accounts that corresponds to the target account identifier as the second account when a duration for which the virtual object identifier stays on the target account identifier satisfies a duration condition may be implemented through the following processing: determining the account in the group of accounts that corresponds to the target account identifier as the second account when the timer corresponding to the target account identifier indicates that the duration for which the virtual object identifier stays on the target account identifier satisfies the duration condition.

After the highlighting the target account identifier, and displaying a timer corresponding to the target account identifier, the following processing may further be included: canceling, when the timer indicates that the duration for which the virtual object identifier stays on the target account identifier does not satisfy the duration condition, the highlighting of the target account identifier in response to a selection cancel sub-operation of controlling the virtual object identifier to leave the target account identifier, and canceling the display of the timer.

A display region corresponding to the group of account identifiers includes display subregions, and an account identifier in the group of account identifiers is in a display subregion. When the virtual object identifier is moved to a display subregion, the account identifier in the display subregion is highlighted, and a timer is displayed in a game picture. If the virtual object identifier is moved to a display subregion corresponding to the target account identifier, the target account identifier is highlighted, and the displayed timer is the timer of the target account identifier. When the duration for which the virtual object identifier stays on the target account identifier satisfies the duration condition, the game picture displayed on the terminal display interface of the first account no longer displays the first virtual scene but display the second virtual scene instead, and displays the first virtual object in the second virtual scene.

In some embodiments, if the virtual object identifier is moved to the display subregion corresponding to the target account identifier, the target account identifier is highlighted. However, the duration for which the virtual object identifier stays on the target account identifier does not satisfy the duration condition, which may be understood as that, in this case, the first account controls the virtual object identifier to move again, to cancel the operation of selecting the account corresponding to the target account identifier as the second account, so that the virtual object identifier is no longer in the display subregion corresponding to the target account identifier, and the highlighting of the target account identifier and the timer is canceled.

According to this embodiment of the present disclosure, by highlighting the target account identifier when the virtual object identifier is moved to the display subregion corresponding to the target account identifier, and using the timer to reflect the duration for which the virtual object identifier stays on the target account identifier, the account corresponding to the target account identifier is determined as the second account when the duration for which the virtual object identifier stays on the target account identifier satisfies the duration condition; otherwise, the second account cannot be determined. This can quickly identify and locate the second account, thereby achieving the technical effect of improving gaming account experience and operation efficiency.

In an exemplary embodiment, using a tactical strategy video game as an example, the present disclosure may be applied to a teammate cooperation application scenario in an auto chess game, in which two accounts form a team. During gameplay, interaction data is generated between the two accounts, and may include, but is not limited to, gifting a virtual resource, or the like. For example, one account gifts a virtual object to another account, so that the another account achieves a game achievement by merging owned low-level virtual objects into a high-level virtual object. In the related art, because pieces are gifted unidirectionally between accounts, when a sender account, that is, the first account, does not communicate with a recipient account in real time, that is, the second account, if the recipient account is overwhelmed with operations and fail to promptly pick up a piece in time from the field, the recipient account cannot use the piece in the game, and the sender account can only gift the piece to the recipient account but cannot help the recipient account use the piece. When the sender account and the recipient account enter the game in a two-player mode, a quantity of decisions and operational costs for the accounts in a period of time of the same round are increased. The solution in the related art fails to conveniently implement the transfer of pieces between the sender account and the recipient account, which makes the two-player mode more difficult than the regular mode. In other words, when the sender account and the recipient account cannot communicate with each other face-to-face or via voice chat, the difficulty of the two-player mode increases due to information errors and insufficient communication in the current communication manners between the two parties.

For example, the virtual object display method provided in the present disclosure may be applied to a teammate cooperation application scenario in an auto chess game in the following manner. It is assumed that a first account and a second account form a team to play the game.

S1: The terminal selects the first virtual object when detecting that the first account performs the following operation on the terminal display interface, where the operation (namely, the object selection sub-operation) may include, but is not limited to, long-pressing the first virtual object, tapping/clicking the first virtual object, double-tapping/clicking the first virtual object, or the like. When the first virtual object is selected, the first virtual object may be moved to a specified region of the terminal display interface by dragging or the like (the account selection sub-operation), to select the second account. The specified region may include, but is not limited to, a right side edge of the terminal display interface, a left side edge of the terminal display interface, a teammate avatar region in an account list on the right side of the terminal display interface, and an account identifier region of the second account in an account list on the left side of the terminal display interface. The account list may include, but is not limited to, an account identifier of the first account, an account identifier of the second account, and account identifiers of other accounts in the team that battle against the first account and the second account.

S2: When an account identifier of the second account (namely, the target account identifier) is highlighted, and the second account enters a ready state, the countdown progress bar (namely, the timer) is displayed in a specified region of the terminal display interface of the first account, to start the countdown. The specified region may include, but is not limited to, a right side, a left side, and the like of the terminal display interface. A duration of the countdown progress bar may be flexibly set. This is not limited in the present disclosure.

S3: When the terminal detects that the first account maintains an action of moving the first virtual object to an account identifier region of the second account on the terminal display interface, that is, moving the first virtual object to the account identifier region of the second account without performing a next action, for example, the first account drags the first virtual object with a finger to the account identifier region of the second account without releasing it, and waits for the end of the countdown progress bar (namely, the duration condition), the terminal displays a chessboard of the second account (namely, the second virtual scene) on the terminal display interface of the first account, so that the first account can view the chessboard of the second account and information displayed on the terminal display interface of the second account.

S4: The displaying the chessboard of the second account on the interface of the first account may include, but is not limited to, performing a subsequent action on the first virtual object, for example, gifting the first virtual object to the second account, and selecting the first virtual object through touchscreen input or the like, and dragging the first virtual object in the chessboard of the second account, that is, the first account dragging the first virtual object to a region in a chessboard battle region of the second account. If a quantity of virtual objects in the chessboard battle region of the second account has not reached an upper quantity limit of virtual objects, the first virtual object is placed as a piece into a region in the chessboard battle region, where the virtual objects in the chessboard battle region may participate in a current battle. In other words, when there is an available region in the chessboard battle region of the second account for placing a piece, if the terminal detects that the first account drags the first virtual object to a region in the chessboard battle region of the second account, after the first account releases it, the first virtual object is displayed in the available region in the chessboard battle region of the second account, so that the second virtual object can enter the current battle as a virtual object of the second account.

S5: When detecting that the first account drags the first virtual object to a region in the chessboard battle region (the first region) of the second account and the quantity of virtual objects in the chessboard battle region of the second account has reached the upper quantity limit of virtual objects, the terminal changes a form of the first virtual object. This may include, but is not limited to, transforming the first virtual object, which is originally in a form of a piece that may enter the current battle, into a form of a virtual loot (namely, the virtual object identifier) that does not enter the current battle, and presenting the virtual loot in the chessboard battle region of the second account. The second account may pick up the first virtual object in the chessboard battle region in the following manners, including, but are not limited to, long-pressing the first virtual object, tapping/clicking the first virtual object, double-tapping/clicking the first virtual object, and the like. In other words, when the quantity of virtual objects in the chessboard battle region of the second account has reached the upper quantity limit of virtual objects and there is no available region for placing the first virtual object, if the terminal detects that the first account drags the first virtual object to the region in the chessboard battle region of the second account, after the first account releases it, the first virtual object is transformed into a display form that facilitates pickup by the second account.

S6: Detect whether the first account drags the first virtual object to the chessboard bench region of the second account. The chessboard bench region of the second account may include, but is not limited to, a plurality of virtual objects. The virtual objects located in the chessboard bench region (namely, the second region) of the second account do not participate in the current battle. A virtual object enters the chessboard battle region for battle only when the second account sends an instruction instructing the virtual object to participate in the battle. The virtual objects located in the chessboard bench region of the second account may be upgraded. An upgrade manner may include, but is not limited to, the following: when a virtual object wins a battle, it usually obtains experience points, and after a quantity of experience points are accumulated, the virtual object is upgraded, to improve an attribute and a capability of the virtual object, or a level of the virtual object is directly increased by using a specific virtual item, or the virtual object is upgraded when located in a specific region of the chessboard, or when a specified quantity of virtual objects of the same type exist, a plurality of low-level virtual objects are merged and upgraded, to obtain a high-level virtual object. For example, two low-level virtual objects of the same type may be merged into one high-level virtual object.

S7-1: In operation S6, assuming that the first account performs a release operation, and in this case, the first virtual object is placed into the chessboard bench region of the second account, if the first virtual object cannot be upgraded in the chessboard bench region of the second account, the first virtual object may be placed into the chessboard bench region of the second account as a virtual object in preparation. The first virtual object is moved to the chessboard battle region for battle only when the second account sends an instruction instructing the first virtual object to participate in the battle. Alternatively, the first virtual object is upgraded when the first virtual object satisfies the upgrade condition, for example, the second account obtains another virtual object of the same type and the same level as the first virtual object, and the terminal may merge the virtual object with the first virtual object, to obtain a higher-level first virtual object.

S7-2: In operation S6, assuming that the first account performs a release operation, and in this case, the first virtual object is placed into the chessboard bench region of the second account, when the first virtual object satisfies the upgrade condition, the terminal upgrades the first virtual object, to obtain a higher-level virtual object D, and places the virtual object D into the chessboard bench region of the second account.

S7-3: In operation S6, assuming that the first account performs a release operation, and in this case, the quantity of virtual objects in the chessboard bench region of the second account has reached the upper limit, that is, no new virtual object can be placed into the chessboard bench region of the second account, the terminal changes a form of the first virtual object, so that the first virtual object is changed into a virtual loot that can be placed into the chessboard battle region and picked up by the second account.

S8: After displaying the chessboard of the second account, the terminal may further cancel the display of the chessboard of the second account and redisplay the first virtual scene of the first account on the terminal display interface when detecting the following operations. The operation includes, but is not limited to, dragging the first virtual object to the cancel button on the terminal display interface and releasing it.

If in operation S1, the first account does not move the first virtual object to the specified region of the terminal display interface, subsequent operations cannot be performed. In other words, in operation S1, whether the first account moves the first virtual object to the specified region of the terminal display interface may be detected. Assuming that the first account moves the first virtual object to the specified region of the terminal display interface, the account identifier region of the second account is highlighted, and the countdown progress bar appears. In addition, a duration of the countdown progress bar may be set to one second. Before the end of the countdown progress bar, if the first account moves the first virtual object out of the specified region of the terminal display interface, the highlighting of the account identifier region of the second account and the display of the countdown progress bar are canceled. If the first account maintains the first virtual object in the specified region of the terminal display interface, the chessboard display is switched, allowing the first account to enter the chessboard of the second account.

In operation S5, assuming that the first account drags the first virtual object to a region in the chessboard battle region of the second account and then releases it, whether the quantity of the virtual objects in the chessboard battle region of the second account has reached an upper level limit of the second account is first determined, and only when the quantity of the virtual objects in the chessboard battle region of the second account has not reached the upper level limit of the second account, the subsequent operation continues to be performed. In a case that the quantity of the virtual objects in the chessboard battle region of the second account has reached the upper level limit of the second account, when the first account dragging the first virtual object to a region in the chessboard battle region of the second account and then performs a release operation, the first virtual object is automatically changed into a virtual loot dropped in the chessboard battle region of the second account. Otherwise, the first virtual object is directly placed into a region in which the first account performs the release operation.

In operation S6, after the first account drags the first virtual object to the chessboard bench region of the second account and releases it, whether a specified quantity of virtual objects of the same level and the same type as the first virtual object already exist in the chessboard bench region of the second account is first determined. In addition, the specified quantity is not specifically limited in the present disclosure. For example, the quantity may be two, three, or the like. The virtual object is a low-level virtual object. If such first virtual objects exist, the first virtual objects are merged and upgraded. That is, assuming that two virtual objects of the same level and the same type as the first virtual object already exist in the chessboard bench region of the second account, the two virtual objects are be merged and upgraded with the first virtual object to obtain a higher-level virtual object, and the virtual object is placed into the chessboard bench region of the second account. In this case, the two virtual objects of the same level and the same type as the first virtual object no longer exist in the chessboard bench region of the second account, and only the upgraded and merged virtual object exists.

In addition, if no specified quantity of virtual objects of the same level and the same type as the first virtual object exist in the chessboard bench region of the second account, whether the quantity of the virtual objects in the chessboard bench region of the second account has reached the upper limit is determined. If the quantity of the virtual objects in the chessboard bench region has reached the upper limit, after the first account drags the first virtual object to the chessboard bench region of the second account and releases it, the first virtual object is automatically changed into a virtual loot dropped on the chessboard of the second account. Otherwise, the first virtual object is directly placed into a region in which the first account performs the release operation.

If the first account performs a release operation within the cancel button on the terminal display interface, it indicates cancellation of gifting the first virtual object to the second account. In this case, the terminal display interface of the first account no longer displays the chessboard of the second account but displays the chessboard of the first account instead, and the first virtual object cancels the drag action.

For example, this solution provides a virtual object display method. An account may gift a virtual object to another account in the same team, and directly assist the recipient account of the virtual object in performing a virtual object preparation operation on the bench. For the gifting account, when gifting the virtual object, there is no need to repeatedly switch between terminal display interfaces of the gifting account and the recipient account to verify gifting information of the virtual object, thereby effectively reducing operational costs. For the recipient account, when there is an available position on the bench or the chessboard, the received virtual object may be directly placed into the bench or directly deployed into battle, without the need to pick up the virtual object from the field, thereby reducing operational steps, and improving processing efficiency of the virtual object. In addition, decision-making pressure of the recipient account within the countdown of the same round is reduced, as accounts in the same team can assist with operations, thereby making the operations smoother and more convenient, decreasing the difficulty of operating the virtual object for the recipient account, and improving gaming experience of the recipient account.

In a specific implementation of the present disclosure, related data such as user information is involved. When the foregoing embodiments of the present disclosure are applied to a specific product or technology, user permission or consent needs to be obtained, and collection, use, and processing of the related data needs to comply with related laws and regulations and standards of related countries and regions.

For ease of description, the foregoing method embodiments are described as a series of action combinations. However, a person skilled in the art needs to appreciate that the present disclosure is not limited to the described order of the actions, because according to the present disclosure, some steps may be performed in other orders or simultaneously. In addition, a person skilled in the art also needs to know that all the embodiments described in this specification are preferred embodiments, and the related actions and modules are not necessarily mandatory to the present disclosure.

According to another aspect of the embodiments of the present disclosure, a virtual object display apparatus configured to implement the foregoing virtual object display method is further provided. As shown in FIG. 17, the apparatus includes:

a first display module 1702, configured to display a first virtual scene corresponding to a first account in a current match, where accounts participating in the current match include a group of accounts, the group of accounts includes the first account, and the first virtual scene displays a group of virtual objects owned by the first account;

a second display module 1704, configured to display a second virtual scene corresponding to a second account and a first virtual object in response to a first interaction operation performed by the first account in the first virtual scene, where the first interaction operation is an operation of determining the first virtual object from the group of virtual objects and determining the second account from accounts in the group of accounts other than the first account; and

a third display module 1706, configured to display the first virtual object in a target region in the second virtual scene in response to a second interaction operation performed by the first account in the second virtual scene, where the second interaction operation is an operation of determining the target region from the second virtual scene, and the display of the first virtual object in the target region indicates that the first virtual object is owned by the second account.

In the solution, the second interaction operation includes: controlling the first virtual object to move to the target region; and the apparatus is configured to display the first virtual object in the target region in the second virtual scene in response to the second interaction operation performed by the first account in the second virtual scene in the following manner: determining a first comparison relationship between a quantity of virtual objects deployed in the target region and a first upper quantity limit in response to the first account controlling the first virtual object to move to the target region in the second virtual scene; and displaying the first virtual object in the target region when the first comparison relationship indicates that the quantity of virtual objects deployed in the target region has not reached the first upper quantity limit.

In the solution, the apparatus is configured to perform the following processing after determines the first comparison relationship between the quantity of virtual objects deployed in the target region and the first upper quantity limit in response to the first account controlling the first virtual object to move to the target region in the second virtual scene: when the first comparison relationship indicates that the quantity of virtual objects deployed in the target region has reached the first upper quantity limit, performing one of the following processing: displaying a virtual object identifier in the target region, where the virtual object identifier is configured for indicating that the first account has transferred the first virtual object to the second account, and the quantity of virtual objects deployed in the target region has reached the first upper quantity limit; determining a second comparison relationship between a quantity of virtual objects deployed in an alternate region corresponding to the target region and a second upper quantity limit, and displaying the first virtual object in the alternate region when the second comparison relationship indicates that the quantity of virtual objects deployed in the alternate region has not reached the second upper quantity limit; or canceling the display of the second virtual scene, and displaying the first virtual scene.

In the solution, the second interaction operation includes: controlling the first virtual object to move to the target region; and the apparatus is further configured to respond to the second interaction operation performed by the first account in the second virtual scene in the following manner: displaying, in response to the first account controlling the first virtual object to move to the target region, and when the target region displays a second virtual object, a third virtual object in the target region, and canceling the display of the second virtual object, where the second virtual object is allowed to be merged with the first virtual object into the third virtual object; and selecting, in response to the first account controlling the first virtual object to move to the target region, and when an alternate region corresponding to the target region displays the second virtual object, one of the target region and the alternate region to display the third virtual object, and canceling the display of the second virtual object.

In the solution, the apparatus is configured to select, in response to the first account controlling the first virtual object to move to the target region, and when an alternate region corresponding to the target region displays the second virtual object, one of the target region and the alternate region to display the third virtual object in the following manner: displaying the third virtual object in the alternate region in response to the first account controlling the first virtual object to move to the target region, and when the alternate region displays the second virtual object, and a quantity of virtual objects deployed in the target region has reached a first upper quantity limit; or displaying the third virtual object in the target region in response to the first account controlling the first virtual object to move to the target region, and when the alternate region displays the second virtual object, and a quantity of virtual objects deployed in the target region has not reached a first upper quantity limit.

In the solution, the second interaction operation includes: controlling the first virtual object to move to a cancel control; and the apparatus is further configured to respond to the second interaction operation performed by the first account in the second virtual scene in the following manner: canceling the display of the second virtual scene in response to the first account controlling the first virtual object to move to the cancel control, displaying the first virtual scene, and displaying the first virtual object in the first virtual scene, the cancel control being a control for canceling transfer of the first virtual object to the second account.

In the solution, the first interaction operation includes: an object selection sub-operation and an account selection sub-operation; and the apparatus is further configured to display the second virtual scene corresponding to the second account and the first virtual object in response to the first interaction operation performed by the first account in the first virtual scene in the following manner: determining the first virtual object from the group of virtual objects in response to the object selection sub-operation, and displaying a virtual object identifier of the first virtual object, where the virtual object identifier is allowed to be controlled to move; moving the virtual object identifier to a target account identifier in response to the account selection sub-operation, and determining an account in the group of accounts that corresponds to the target account identifier as the second account; and displaying the corresponding second virtual scene in response to the second account being determined, and displaying the first virtual object in the second virtual scene.

In the solution, the object selection sub-operation includes: a first operation or a second operation; and the apparatus is configured to determine the first virtual object from the group of virtual objects in response to the object selection sub-operation, and display a virtual object identifier of the first virtual object in one of the following manners: determining, in response to the first operation of selecting a virtual object in the group of virtual objects, the virtual object corresponding to the first operation as the first virtual object, and displaying the virtual object identifier; or determining, in response to the second operation of applying a target virtual item to a virtual object in the group of virtual objects, the virtual object to which the target virtual item is applied as the first virtual object, and displaying the virtual object identifier, where the target virtual item is configured for transferring virtual objects between different accounts.

In the solution, the apparatus is further configured to determine the account in the group of accounts that corresponds to the target account identifier as the second account in the following manner: determining the account in the group of accounts that corresponds to the target account identifier as the second account when a duration for which the virtual object identifier stays on the target account identifier satisfies a duration condition.

In the solution, the apparatus is further configured to: highlight the target account identifier, and display a timer corresponding to the target account identifier; and determine the account in the group of accounts that corresponds to the target account identifier as the second account when the timer indicates that the duration for which the virtual object identifier stays on the target account identifier satisfies the duration condition.

In the solution, the apparatus is further configured to: cancel, when the timer indicates that the duration for which the virtual object identifier maintains on the target account identifier does not satisfy the duration condition, the highlighting of the target account identifier in response to a selection cancel sub-operation of controlling the virtual object identifier to leave the target account identifier, and cancel the display of the timer.

In the embodiments of the present disclosure, the term "module" or "unit" refers to a computer program having a predetermined function or a part of a computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Specific manners of performing operations by the modules in the apparatus in the foregoing embodiments are described in detail in the embodiments related to the methods, and are not described in detail herein.

An embodiment of the present disclosure provides a computer program product. The computer program product includes a computer program or computer-executable instructions. The computer program or the computer-executable instructions, when executed by a processor, implement the virtual object display method provided in the embodiments of the present disclosure.

The sequence numbers of the foregoing embodiments of the present disclosure are merely for description purpose but do not indicate the preference of the embodiments.

FIG. 18 is a schematic structural block diagram of a computer system for implementing an electronic device according to an embodiment of the present disclosure.

A computer system 1800 of the electronic device shown in FIG. 18 is merely an example, and does not constitute any limitation on functions and use ranges of the embodiments of the present disclosure.

As shown in FIG. 18, the computer system 1800 includes a central processing unit (CPU) 1801, which may perform various suitable actions and processing according to a program stored in a read-only memory (ROM) 1802 or a program loaded from a storage part 1808 to a random access memory (RAM) 1803. The random access memory 1803 further has various programs and data required by system operations stored therein. The central processing unit 1801, the read-only memory 1802, and the random access memory 1803 are connected to each other by using a bus 1804. An input/output interface (I/O interface) 1805 is also connected to the bus 1804.

The following components are connected to the input/output interface 1805: an input part 1806 including a keyboard, a mouse, and the like; an output part 1807, including a cathode ray tube (CRT), a liquid crystal display (LCD), a speaker, and the like; a storage part 1808 including a hard disk; and a communication part 1809 including a network interface card such as a local area network card and a modem. The communication part 1809 performs communication processing by using a network such as the Internet. A drive 1810 is also connected to the input/output interface 1805 as required. A removable medium 1811, such as a magnetic disk, an optical disc, a magneto-optical disk, or a semiconductor memory, is installed on the drive 1810 as required, so that a computer program read from the removable medium 1811 is installed into the storage part 1808 as required.

Particularly, according to this embodiment of the present disclosure, processes described in the flowcharts of the methods may be implemented as computer software programs. For example, this embodiment of the present disclosure includes a computer program product, which includes a computer program or computer-executable instructions loaded on a computer-readable medium, and the computer program or the computer-executable instructions include program code configured to perform the method shown in the flowcharts. In such an embodiment, the computer program may be downloaded and installed from a network by using the communication part 1809 and/or installed from the removable medium 1811. The computer program or the computer-executable instructions, when executed by the central processing unit 1801, perform various functions defined in the system of the present disclosure.

In such an embodiment, the computer program or the computer-executable instructions may be downloaded and installed from a network by using the communication part 1809 and/or installed from the removable medium 1811. The computer program or the computer-executable instructions, when executed by the central processing unit 1801, perform various functions provided in the embodiments of the present disclosure.

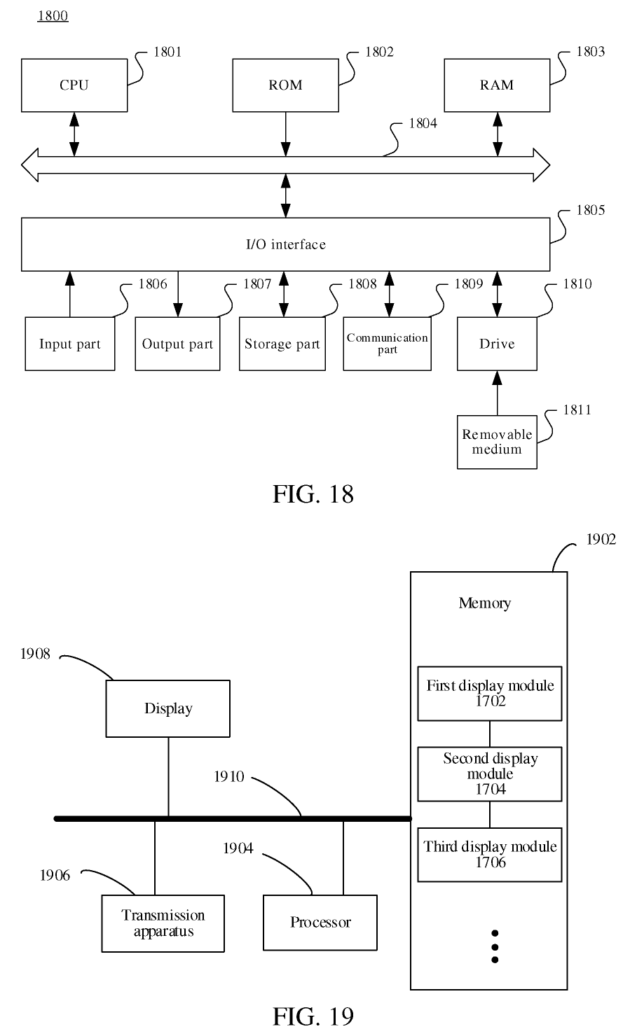

According to another aspect of the embodiments of the present disclosure, an electronic device configured to implement the foregoing virtual object display method is further provided. The electronic device may be the terminal or the server shown in FIG. 1. This embodiment is described by using an example in which the electronic device is a terminal. As shown in FIG. 19, the electronic device includes a memory 1902 and a processor 1904. The memory 1902 has a computer program or computer-executable instructions stored therein, and the processor 1904 is configured to perform the operations in any one of the foregoing method embodiments through the computer program or the computer-executable instructions.

In this embodiment, the electronic device may be located in at least one of a plurality of network devices in a computer network.

In this embodiment, the processor may be configured to perform the method in the embodiments of the present disclosure through a computer program.

A person of ordinary skill in the art may understand that the structure shown in FIG. 19 is only for the purpose of illustration, and FIG. 19 does not constitute a limitation to the structure of the electronic device. For example, the electronic device may further include more or fewer components (such as a network interface) than those shown in FIG. 19, or have a configuration different from that shown in FIG. 19.

The memory 1902 may be configured to store a software program and module, for example, a program instruction/module corresponding to the virtual object display method and apparatus in the embodiments of the present disclosure. The processor 1904 runs the software program and module stored in the memory 1902, to implement various functional applications and data processing, that is, implement the foregoing virtual object display method. The memory 1902 may include a high-speed random access memory, and may further include a non-volatile memory such as one or more magnetic storage apparatuses, a flash memory, or another non-volatile solid-state memory. In some examples, the memory 1902 may further include a memory remotely disposed relative to the processor 1904, and these remote memories may be connected to the terminal through a network. Examples of the network include, but are not limited to, the Internet, an intranet, a local area network, a mobile communication network, and a combination thereof. The memory 1902 may be specifically, but is not limited to, configured to store information such as a first virtual object, a second virtual object, and a third virtual object. In an example, as shown in FIG. 19, the memory 1902 may include, but is not limited to, the first display module 1702, the second display module 1704, and the third display module 1706 in the foregoing virtual object display apparatus. In addition, the memory 1902 may further include, but is not limited to, another module unit in the virtual object display apparatus. Details are not described herein again.

The transmission apparatus 1906 is configured to receive or send data by using a network. Specific examples of the network may include a wired network and a wireless network. In an example, the transmission apparatus 1906 includes a network interface controller (NIC), which may be connected to another network device and a router by using a network cable, so as to communicate with the Internet or a local area network. In an example, the transmission apparatus 1906 is a radio frequency (RF) module, which is configured to communicate with the Internet in a wireless manner.

In addition, the electronic device further includes: a display 1908, configured to display the foregoing first virtual scene and the foregoing second virtual scene; and a connection bus 1910, configured to connect various module components in the electronic device.

In other embodiments, the terminal or the server may be a node in a distributed system. The distributed system may be a blockchain system. The blockchain system may be a distributed system formed by connecting a plurality of nodes in a network communication form. The nodes may form a point-to-point network. Any form of computing device, for example, an electronic device such as a server or a terminal, can be added to the point-to-point network to become a node in the blockchain system.

An embodiment of the present disclosure provides a computer-readable storage medium. A processor of an electronic device reads a computer program or computer-executable instructions from the computer-readable storage medium, and the processor executes the computer program or the computer-executable instructions, to cause the electronic device to perform the virtual object display method provided in various exemplary implementations of the foregoing virtual object display method.

In this embodiment, the computer-readable storage medium may be configured to store the computer program or the computer-executable instructions configured for performing the method in the embodiments of the present disclosure.

In this embodiment, a person of ordinary skill in the art may understand that all or some of the steps of the methods in the foregoing embodiments may be implemented by a program instructing relevant hardware of a terminal. The program may be stored in a computer-readable storage medium. The storage medium may include: a flash drive, a read-only memory (ROM), a random access memory (RAM), a magnetic disk, an optical disc, or the like.

The sequence numbers of the foregoing embodiments of the present disclosure are merely for description purpose but do not indicate the preference of the embodiments.

When the integrated unit in the foregoing embodiments is implemented in a form of a software functional unit and sold or used as an independent product, the integrated unit may be stored in the computer-readable storage medium. Based on such an understanding, the technical solutions of the present disclosure essentially, or the part contributing to the related art, or all or some of the technical solutions may be implemented in a form of a software product. The computer software product is stored in a storage medium and includes several instructions for instructing one or more electronic devices to perform all or some of the steps of the methods described in the embodiments of the present disclosure.

In the foregoing embodiments of the present disclosure, descriptions of the embodiments have respective focuses. For parts that are not described in detail in an embodiment, refer to related descriptions in other embodiments.

In the several embodiments provided in the present disclosure, the disclosed application may be implemented in other manners. The described apparatus embodiments are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

The foregoing descriptions are merely preferred implementations of the present disclosure, and a person of ordinary skill in the art may make various improvements and refinements without departing from the principle of the present disclosure. All such modifications and refinements also need to be intended to be within the protection scope of the present disclosure.

What is claimed is:

1. A virtual object display method, performed by an electronic device, comprising:
displaying a first virtual scene corresponding to a first account in a current match, the first virtual scene displaying a group of virtual objects owned by the first account, wherein a group of accounts participate in the current match, the group of accounts comprising the first account;
displaying, in response to a first interaction operation performed by the first account in the first virtual scene, a second virtual scene corresponding to a second account and a first virtual object in the second virtual scene, the first interaction operation being an operation of determining the first virtual object from the group of virtual objects and determining the second account from the group of accounts, the second account being different from the first account; and
displaying, in response to a second interaction operation performed by the first account in the second virtual scene, the first virtual object in a target region in the second virtual scene, the second interaction operation being an operation of determining the target region from the second virtual scene, and displaying the first virtual object in the target region indicating that the first virtual object is owned by the second account.

2. The method according to claim 1, wherein the second interaction operation comprises controlling the first virtual object to move to the target region; and
wherein displaying the first virtual object in the target region in the second virtual scene comprises:
in response to the first account controlling the first virtual object to move to the target region in the second virtual scene, determining a first comparison relationship between a quantity of virtual objects deployed in the target region and a first upper quantity limit; and
displaying, when the first comparison relationship indicates that the quantity of virtual objects deployed in the target region has not reached the first upper quantity limit, the first virtual object in the target region.

3. The method according to claim 2, wherein after determining the first comparison relationship between the quantity of virtual objects deployed in the target region and the first upper quantity limit, the method further comprises:
when the first comparison relationship indicates that the quantity of virtual objects deployed in the target region has reached the first upper quantity limit, performing one of the following processing:
displaying a virtual object identifier in the target region, the virtual object identifier being configured for indicating that the first account has transferred the first virtual object to the second account and that the quantity of virtual objects deployed in the target region has reached the first upper quantity limit;
determining a second comparison relationship between a quantity of virtual objects deployed in an alternate region corresponding to the target region and a second upper quantity limit, and displaying the first virtual object in the alternate region when the second comparison relationship indicates that the quantity of virtual objects deployed in the alternate region has not reached the second upper quantity limit; and
canceling displaying the second virtual scene and displaying the first virtual scene.

4. The method according to claim 1, wherein the second interaction operation comprises controlling the first virtual object to move to the target region; and
in response to the second interaction operation performed by the first account in the second virtual scene, the method further comprises:
in response to the first account controlling the first virtual object to move to the target region and when the target region displays a second virtual object, displaying a third virtual object in the target region, and canceling displaying the second virtual object, the second virtual object being allowed to be merged with the first virtual object into the third virtual object; and
in response to the first account controlling the first virtual object to move to the target region and when an alternate region corresponding to the target region displays the second virtual object, selecting one of the target region and the alternate region to display the third virtual object, and canceling displaying the second virtual object.

5. The method according to claim 4, wherein selecting one of the target region and the alternate region to display the third virtual object comprises:
displaying, in response to the first account controlling the first virtual object to move to the target region, the second virtual object in the alternate region, and in response to the first account controlling the first virtual object to move to the target region and when a quantity of virtual objects deployed in the target region has reached a first upper quantity limit, displaying the third virtual object in the alternate region; and
displaying, in response to the first account controlling the first virtual object to move to the target region, the second virtual object in the alternate region, and in response to the first account controlling the first virtual object to move to the target region and when a quantity of virtual objects deployed in the target region has not reached a first upper quantity limit, displaying the third virtual object in the target region.

6. The method according to claim 3, wherein when the target region comprises a first region, the alternate region comprises a second region, and when the target region comprises the second region, the alternate region comprises the first region, the first region being configured for deploying a first set of virtual objects, wherein the first set of virtual objects are used by the second account in a next round of the current match, and the second region being configured for deploying a second set of virtual objects, wherein the second set of virtual objects are not used by the second account in the next round of the current match and are owned by the second account.

7. The method according to claim 1, wherein the second interaction operation comprises controlling the first virtual object to move to a cancel control; and
in response to the second interaction operation performed by the first account in the second virtual scene, the method further comprises:
in response to the first account controlling the first virtual object to move to the cancel control, canceling the display of the second virtual scene, displaying the first virtual scene, and displaying the first virtual object in the first virtual scene, the cancel control being a control for canceling transfer of the first virtual object to the second account.

8. The method according to claim 1, wherein the first interaction operation comprises an object selection sub-operation and an account selection sub-operation; and wherein displaying the second virtual scene corresponding to the second account and the first virtual object comprises:
in response to the object selection sub-operation, determining the first virtual object from the group of virtual objects and displaying a virtual object identifier of the first virtual object, the virtual object identifier being allowed to be controlled to move;
in response to the account selection sub-operation, moving the virtual object identifier to a target account identifier and determining an account in the group of accounts that corresponds to the target account identifier as the second account; and
in response to the second account being determined, displaying the corresponding second virtual scene and displaying the first virtual object in the second virtual scene.

9. The method according to claim 8, wherein the object selection sub-operation comprises a first operation or a second operation; and
wherein determining the first virtual object from the group of virtual objects and displaying a virtual object identifier of the first virtual object comprises one of the following processing:
in response to the first operation of selecting a virtual object in the group of virtual objects, determining the virtual object corresponding to the first operation as the first virtual object and displaying the virtual object identifier; or
in response to the second operation of applying a target virtual item to a virtual object in the group of virtual objects, determining the virtual object as the first virtual object and displaying the virtual object identifier, the target virtual item being configured for transferring virtual objects between different accounts.

10. The method according to claim 8, wherein determining the account in the group of accounts that corresponds to the target account identifier as the second account comprises:
determining the account in the group of accounts that corresponds to the target account identifier as the second account when a duration for the virtual object identifier staying on the target account identifier satisfies a duration condition.

11. The method according to claim 10, wherein after moving the virtual object identifier to the target account identifier, and before determining the account in the group of accounts that corresponds to the target account identifier as the second account when the duration for the virtual object identifier staying on the target account identifier satisfies the duration condition, the method further comprises:
highlighting the target account identifier, and displaying a timer corresponding to the target account identifier; and
wherein determining the account in the group of accounts that corresponds to the target account identifier as the second account when the duration for the virtual object identifier staying on the target account identifier satisfies the duration condition comprises:
determining the account in the group of accounts that corresponds to the target account identifier as the second account when the timer indicates that the duration for the virtual object identifier staying on the target account identifier satisfies the duration condition.

12. The method according to claim 11, wherein after highlighting the target account identifier, and displaying the timer corresponding to the target account identifier, the method further comprises:
when the timer indicates that the duration for the virtual object identifier staying on the target account identifier does not satisfy the duration condition, and in response to a selection cancel sub-operation of controlling the virtual object identifier to leave the target account identifier, cancelling the highlighting and canceling the display of the timer.

13. A virtual object display apparatus, comprising a memory for storing instructions and a processor for executing the instructions to:
display a first virtual scene corresponding to a first account in a current match, the first virtual scene displaying a group of virtual objects owned by the first account, wherein a group of accounts participate in the current match, the group of accounts comprising the first account;
display, in response to a first interaction operation performed by the first account in the first virtual scene, a second virtual scene corresponding to a second account and a first virtual object in the second virtual scene, the first interaction operation being an operation of determining the first virtual object from the group of virtual objects and determining the second account from the group of accounts, the second account being different from the first account; and
display, in response to a second interaction operation performed by the first account in the second virtual scene, the first virtual object in a target region in the second virtual scene, the second interaction operation being an operation of determining the target region from the second virtual scene, and displaying the first virtual object in the target region indicating that the first virtual object is owned by the second account.

14. The virtual object display apparatus according to claim 13, wherein the second interaction operation comprises controlling the first virtual object to move to the target region; and wherein the processor, when being configured to display the first virtual object in the target region in the second virtual scene, is configured to execute the instructions to:
in response to the first account controlling the first virtual object to move to the target region in the second virtual scene, determine a first comparison relationship between a quantity of virtual objects deployed in the target region and a first upper quantity limit; and
display, when the first comparison relationship indicates that the quantity of virtual objects deployed in the target region has not reached the first upper quantity limit, the first virtual object in the target region.

15. The virtual object display apparatus according to claim 14, wherein the processor, after being configured to determine the first comparison relationship between the quantity of virtual objects deployed in the target region and the first upper quantity limit, is configured to execute the instructions to:
when the first comparison relationship indicates that the quantity of virtual objects deployed in the target region has reached the first upper quantity limit, perform one of the following processing:
display a virtual object identifier in the target region, the virtual object identifier being configured for indicating that the first account has transferred the first virtual object to the second account and that the quantity of virtual objects deployed in the target region has reached the first upper quantity limit;
determine a second comparison relationship between a quantity of virtual objects deployed in an alternate region corresponding to the target region and a second upper quantity limit, and display the first virtual object in the alternate region when the second comparison relationship indicates that the quantity of virtual objects deployed in the alternate region has not reached the second upper quantity limit; and
cancel displaying the second virtual scene and display the first virtual scene.

16. The virtual object display apparatus according to claim 13, wherein the second interaction operation comprises controlling the first virtual object to move to the target region; and
wherein in response to the second interaction operation performed by the first account in the second virtual scene, the processor is configured to execute the instructions to:
in response to the first account controlling the first virtual object to move to the target region and when the target region displays a second virtual object, display a third virtual object in the target region, and cancel displaying the second virtual object, the second virtual object being allowed to be merged with the first virtual object into the third virtual object; and
in response to the first account controlling the first virtual object to move to the target region and when an alternate region corresponding to the target region displays the second virtual object, select one of the target region and the alternate region to display the third virtual object, and cancel displaying the second virtual object.

17. The virtual object display apparatus according to claim 16, wherein the processor, when being configured to select one of the target region and the alternate region to display the third virtual object, is configured to execute the instructions to:
display, in response to the first account controlling the first virtual object to move to the target region, the second virtual object in the alternate region, and in response to the first account controlling the first virtual object to move to the target region and when a quantity of virtual objects deployed in the target region has reached a first upper quantity limit, display the third virtual object in the alternate region; and
display, in response to the first account controlling the first virtual object to move to the target region, the second virtual object in the alternate region, and in response to the first account controlling the first virtual object to move to the target region and when a quantity of virtual objects deployed in the target region has not reached a first upper quantity limit., display the third virtual object in the target region.

18. The virtual object display apparatus according to claim 15, wherein when the target region comprises a first region, the alternate region comprises a second region, and when the target region comprises the second region, the alternate region comprises the first region, the first region being configured for deploying a first set of virtual objects, wherein the first set of virtual objects are used by the second account in a next round of the current match, and the second region being configured for deploying a second set of virtual objects, wherein the second set of virtual objects are not used by the second account in the next round of the current match and are owned by the second account.

19. The virtual object display apparatus according to claim 13, wherein the second interaction operation comprises controlling the first virtual object to move to a cancel control; and
wherein in response to the second interaction operation performed by the first account in the second virtual scene, the processor is configured to execute the instructions to:
in response to the first account controlling the first virtual object to move to the cancel control, cancel the display of the second virtual scene, display the first virtual scene, and display the first virtual object in the first virtual scene, the cancel control being a control for canceling transfer of the first virtual object to the second account.

20. A non-transitory computer readable medium storing a plurality of instructions, wherein the plurality of instructions, when executed by a processor, configure the instructions to:
display a first virtual scene corresponding to a first account in a current match, the first virtual scene displaying a group of virtual objects owned by the first account, wherein a group of accounts participate in the current match, the group of accounts comprising the first account;
display, in response to a first interaction operation performed by the first account in the first virtual scene, a second virtual scene corresponding to a second account and a first virtual object in the second virtual scene, the first interaction operation being an operation of determining the first virtual object from the group of virtual objects and determining the second account from the group of accounts, the second account being different from the first account; and
display, in response to a second interaction operation performed by the first account in the second virtual scene, the first virtual object in a target region in the second virtual scene, the second interaction operation being an operation of determining the target region from the second virtual scene, and displaying the first virtual object in the target region indicating that the first virtual object is owned by the second account.
